(19) United States
(12) Patent Application Publication
(10) Pub. No.: US 2026/0181301 A1
(43) Pub. Date: Jun. 25, 2026

(54) SOUND SIGNAL OUTPUT APPARATUS

(71) Applicant: NTT, Inc., Tokyo (JP)

(72) Inventors: Tatsuya KAKO, Musashino-shi, Tokyo (JP); Hironobu CHIBA, Musashino-shi, Tokyo (JP)

(73) Assignee: NTT, Inc., Tokyo (JP)

(21) Appl. No.: 19/127,738

(22) PCT Filed: Nov. 10, 2022
(86) PCT No.: PCT/JP2022/041813

§ 371 Date: May 7, 2025

(51) Int. Cl. H04R 1/10; H04R 1/02; H04R 1/24; H04R 1/28

(52) U.S. Cl. CPC H04R 1/1016; H04R 1/02; H04R 1/023; H04R 1/028; H04R 1/1008; H04R 1/1075; H04R 1/24; H04R 1/288

(57) ABSTRACT

An acoustic signal output device including: a speaker unit; a collar that is a housing accommodating a part of the speaker unit to cause a negative phase sound emitted from the speaker unit in a back surface direction of the speaker unit to travel around in a front surface direction of the speaker unit; and a ring collar that is a ring-shaped member having a size capable of covering a periphery of the collar in a side surface direction, in which the collar is provided with a first negative phase sound emission hole for emitting the negative phase sound in the front surface direction of the speaker unit.

### TECHNICAL FIELD

The present invention relates to an acoustic signal output technology that can be used in an acoustic system installed in a seat of an aircraft, an automobile, or the like.

### BACKGROUND ART

Conventionally, a user uses earphones or headphones to view and listen to movies or music in an aircraft. This is because when a speaker is used, the reproduced sound reaches the periphery of the user, which annoy other users. However, wearing earphones or headphones is troublesome for the user. In addition, there are users who do not like wearing due to, for example, disheveling of hair. Some users do not like pressure on their ears due to wearing. Furthermore, wearing earphones or headphones for a long time may make the user feel tired of listening.

In order to eliminate the need to wear earphones or headphones, it is conceivable to synthesize a virtual sound field using a wavefront synthesis technology, but in this case, it is necessary to prepare a large-scale speaker array, which is not realistic. Therefore, Patent Literature 1 discloses an acoustic signal output technology for a user who uses a seat in an aircraft, which is capable of reproducing a sound that cannot be heard by surrounding users without using earphones or headphones.

### CITATION LIST

### Patent Literature

Patent Literature 1: JP 6958763 B1

### SUMMARY OF INVENTION

### Technical Problem

However, the technology of Patent Literature 1 has a problem that a sweet spot that is an area where emitted sound can be heard is narrow. In addition, the technology of Patent Literature 1 also has a problem that two speaker units are necessary to emit a sound based on one acoustic signal.

Therefore, an object of the present invention is to provide an acoustic signal output technology capable of enlarging the sweet spot in a limited area such as the vicinity of a speaker unit.

### Solution to Problem

One aspect of the present invention is an acoustic signal output device including: a speaker unit; a collar that is a housing accommodating a part of the speaker unit to cause a sound (hereinafter, referred to as a negative phase sound) emitted from the speaker unit in a back surface direction of the speaker unit to travel around in a front surface direction of the speaker unit; and a ring collar that is a ring-shaped member having a size capable of covering a periphery of the collar in a side surface direction, in which the collar is provided with a hole (hereinafter, referred to as a first negative phase sound emission hole) for emitting the negative phase sound in the front surface direction of the speaker unit, and the collar accommodates a part of the speaker unit in such a manner that a path from a hole of the speaker unit for emitting the negative phase sound to the first negative phase sound emission hole is short so that the negative phase sound emitted from the first negative phase sound emission hole and a sound (hereinafter, referred to as a positive phase sound) emitted from the speaker unit in the front surface direction of the speaker unit have a substantially anti-phase relationship in a predetermined frequency band in the front surface direction of the speaker unit, and a resonance frequency of an internal space of the collar formed with respect to the speaker unit is high.

### Advantageous Effects of Invention

According to the present invention, it is possible to enlarge the sweet spot in a limited area such as the vicinity of the speaker unit.

### BRIEF DESCRIPTION OF DRAWINGS

FIG. 1 is a diagram for describing a positive phase sound and a negative phase sound.

FIG. 2 is a diagram illustrating an example of a configuration of an acoustic signal output device 100.

FIG. 3 is a diagram illustrating an example of a configuration of the acoustic signal output device 100.

FIG. 4 is a diagram illustrating a state in which the acoustic signal output device 100 emits a positive phase sound and a negative phase sound.

FIG. 5 is a diagram for describing Helmholtz resonance in the acoustic signal output device 100.

FIG. 6 is a diagram illustrating an example of the acoustic signal output device 100 including a baffle.

FIG. 7 is a diagram illustrating an example of a configuration of the acoustic signal output device 100.

FIG. 8 is a diagram illustrating an example of a configuration of the acoustic signal output device 100.

FIG. 9 is a diagram relating to a first modification of a first embodiment.

FIG. 10 is a diagram relating to a second modification of the first embodiment.

FIG. 11 is a diagram relating to a third modification of the first embodiment.

FIG. 12 is a diagram relating to a fourth modification of the first embodiment.

FIG. 13 is a diagram relating to a fifth modification of the first embodiment.

FIG. 14 is a diagram relating to a sixth modification of the first embodiment.

FIG. 15 is a diagram relating to a seventh modification of the first embodiment.

FIG. 16 is a diagram illustrating an acoustic signal output device used in an experiment.

FIG. 17 is a diagram illustrating experimental results.

FIG. 18 is a diagram illustrating an example of a configuration of an acoustic signal output device 200.

FIG. 19 is a diagram illustrating an example of a configuration of the acoustic signal output device 200.

FIG. 20 is a diagram illustrating a state in which the acoustic signal output device 200 emits a positive phase sound and a negative phase sound.

FIG. 21 is a diagram illustrating an example of the acoustic signal output device 200 including a baffle.

FIG. 22 is a diagram illustrating an example of a configuration of the acoustic signal output device 200.

FIG. 23 is a diagram illustrating an example of a configuration of the acoustic signal output device 200.

FIG. 24 is a diagram relating to a first modification of a second embodiment.

FIG. 25 is a diagram relating to a second modification of the second embodiment.

FIG. 26 is a diagram relating to a third modification of the second embodiment.

FIG. 27 is a diagram relating to a fourth modification of the second embodiment.

FIG. 28 is a diagram relating to a fifth modification of the second embodiment.

FIG. 29 is a diagram relating to a sixth modification of the second embodiment.

FIG. 30 is a diagram relating to a seventh modification of the second embodiment.

FIG. 31 is a diagram illustrating an acoustic signal output device used in an experiment.

FIG. 32 is a diagram illustrating experimental results.

FIG. 33 is a diagram illustrating an example of a configuration of an acoustic signal output device 300.

FIG. 34 is a diagram illustrating an example of a configuration of the acoustic signal output device 300.

FIG. 35 is a diagram illustrating a state in which the acoustic signal output device 300 emits a positive phase sound and a negative phase sound.

FIG. 36 is a diagram for describing Helmholtz resonance in the acoustic signal output device 300.

FIG. 37 is a diagram for describing a longitudinal direction and a lateral direction of the baffle.

FIG. 38 is a diagram relating to a first modification of a third embodiment.

FIG. 39 is a diagram relating to the first modification of the third embodiment.

FIG. 40 is a diagram relating to a second modification of the third embodiment.

FIG. 41 is a diagram relating to a third modification of the third embodiment.

FIG. 42 is a diagram illustrating an example of a configuration of an acoustic signal output device 400.

FIG. 43 is a diagram illustrating an example of a configuration of an acoustic signal output device 500.

FIG. 44 is a diagram illustrating an example of a configuration of the acoustic signal output device 500.

FIG. 45 is a diagram illustrating an example of a vehicular acoustic signal output device 500.

FIG. 46 is a diagram illustrating an example of a configuration of an acoustic signal output device 600.

FIG. 47 is a diagram illustrating an example of a configuration of the acoustic signal output device 600.

FIG. 48 is a diagram illustrating an example of the acoustic signal output device 600 including a frame.

FIG. 49 is a diagram illustrating an example of a configuration of an acoustic signal output device 700.

FIG. 50 is a diagram illustrating an example of a configuration of the acoustic signal output device 700.

FIG. 51 is a diagram illustrating an example of the acoustic signal output device 700 including a ring collar having an illumination function.

FIG. 52 is a diagram illustrating an example of a configuration of the acoustic signal output device 700.

### DESCRIPTION OF EMBODIMENTS

Hereinafter, embodiments of the present invention will be described in detail. Note that components having the same function are denoted by the same reference numeral, and redundant description will be omitted.

### First Embodiment

A device that reproduces an acoustic signal obtained on the basis of a reproduction target is referred to as an acoustic signal output device. That is, the acoustic signal output device is a device that reproduces an input acoustic signal as a sound (hereinafter, this sound is referred to as a sound based on an acoustic signal), and includes a speaker unit. Here, the speaker unit is a device that converts an acoustic signal into a sound. In addition, the reproduction target is, for example, data or a signal based on which it is possible to obtain an acoustic signal by predetermined processing, such as data recorded in a CD, a DVD, or a record, data received through the Internet, or a signal received through radio broadcasting or television broadcasting.

Here, the acoustic signal output device that reproduces an acoustic signal obtained from a reproduction target so that only a user in the vicinity of the speaker unit can hear a sound based on the acoustic signal will be described. That is, the reproduced sound of the acoustic signal output device cannot be heard by users other than the user in the vicinity of the speaker unit. When such an acoustic signal output device is used, for example, as an acoustic system for a user who uses a seat of an aircraft, it is possible to provide a system in which only the user who uses the seat can hear the reproduced sound. Note that such an acoustic system can also be installed in seats of vehicles other than aircrafts such as automobiles and trains, a reclining chair, and the like, and can also be installed in a wearable form such as being placed on a shoulder.

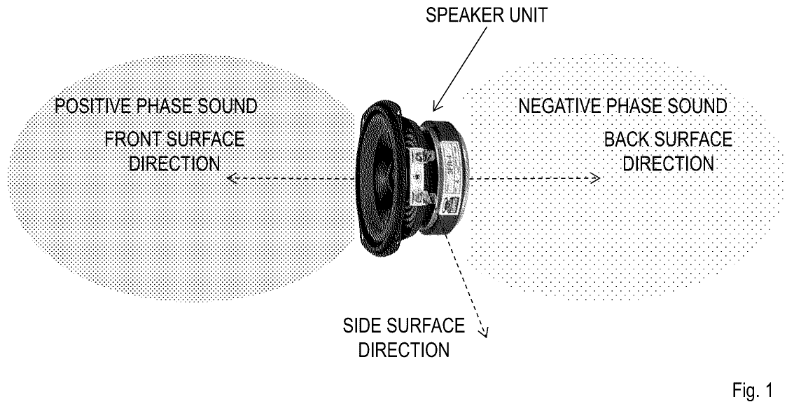

As illustrated in FIG. 1, a sound emitted from the speaker unit in a front surface direction of the speaker unit is referred to as a positive phase sound, and a sound emitted from the speaker unit in a back surface direction of the speaker unit is referred to as a negative phase sound. The negative phase sound is a sound having a phase opposite to the phase of the positive phase sound, that is, a sound having a phase obtained by inverting the phase of the positive phase sound 180 degrees, and the positive phase sound and the negative phase sound have an anti-phase relationship. Note that a direction perpendicular to the front surface direction and the back surface direction is referred to as a side surface direction.

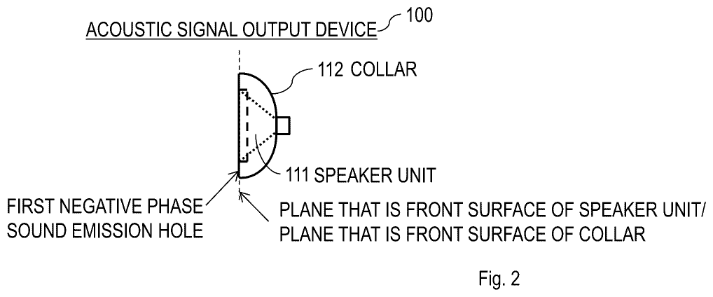

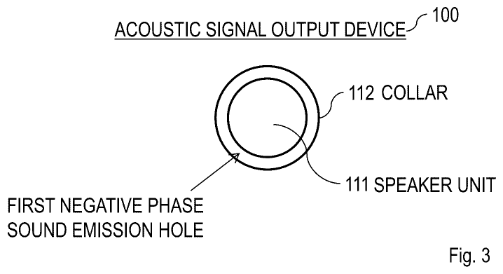

Hereinafter, the acoustic signal output device 100 will be described with reference to FIGS. 2 to 8. FIGS. 2 and 3 are diagrams illustrating a configuration of the acoustic signal output device 100, FIG. 2 is a diagram illustrating a state in which the acoustic signal output device 100 is viewed from the side surface direction, and FIG. 3 is a diagram illustrating a state in which the acoustic signal output device 100 is viewed from the front surface direction. As illustrated in FIG. 2, the acoustic signal output device 100 includes a speaker unit 111 and a collar 112. The speaker unit 111 is a component including a diaphragm (not illustrated) that converts an acoustic signal into vibration of air (that is, generates a sound wave). That is, the speaker unit 111 is a component that reproduces an input acoustic signal as a sound. The collar 112 is a housing that accommodates a part of the speaker unit 111. Note that, in FIG. 2, a part of the speaker unit 111 (a part accommodated in the collar 112) is not visible from the side surface direction, and thus is indicated by the dotted lines. In addition, in FIG. 2, the shapes of a portion of the speaker unit 111 that emits the positive phase sound and the negative phase sound and the collar 112 have a cone shape and a bowl shape, respectively.

Note that, as illustrated in FIG. 2, a plane that is the front surface of the speaker unit 111 and a plane that is the front surface of the collar 112 are preferably substantially parallel. In FIG. 2, the two planes are substantially the same.

The collar 112 is a housing for causing the negative phase sound, which is a sound emitted from the speaker unit 111 in the back surface direction of the speaker unit 111, to travel around in the front surface direction of the speaker unit 111, and the collar 112 is provided with a hole (hereinafter, referred to as a first negative phase sound emission hole) for emitting the negative phase sound that has traveled around in the front surface direction of the speaker unit 111. Note that, in FIG. 2, since the first negative phase sound emission hole is not visible from the side surface direction, the first negative phase sound emission hole is indicated by the broken line.

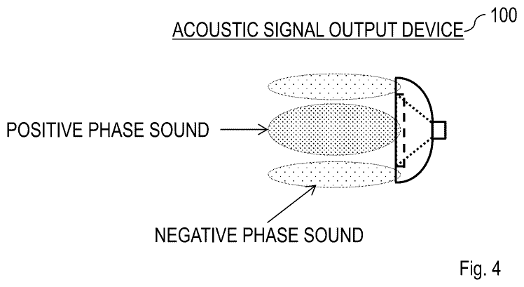

FIG. 4 is a diagram illustrating a state in which the acoustic signal output device 100 emits a positive phase sound and a negative phase sound. More specifically, the acoustic signal output device 100 emits the positive phase sound from the speaker unit 111 in the front surface direction of the speaker unit 111, and emits the negative phase sound from the first negative phase sound emission hole in the front surface direction of the speaker unit 111. At this time, in order to allow only the user in the vicinity of the speaker unit 111 to hear the sound and prevent the other users from hearing the sound, it is preferable that the positive phase sound and the negative phase sound have a substantially anti-phase relationship in the plane that is the front surface of the speaker unit 111. That is, it is preferable that the positive phase sound, which is a sound emitted from the speaker unit 111 in the front surface direction of the speaker unit 111, and the negative phase sound emitted from the first negative phase sound emission hole in the front surface direction of the speaker unit 111 have a substantially anti-phase relationship. More specifically, in a predetermined frequency band in the front surface direction of the speaker unit 111, it is preferable that the positive phase sound emitted from the speaker unit 111 in the front surface direction of the speaker unit 111 and the negative phase sound emitted from the first negative phase sound emission hole in the front surface direction of the speaker unit 111 have a substantially anti-phase relationship. Here, the predetermined frequency band is desirably a band lower than or equal to a frequency (hereinafter, referred to as a resonance frequency) at which resonance in the internal space of the collar 112 formed with respect to the speaker unit 111 occurs.

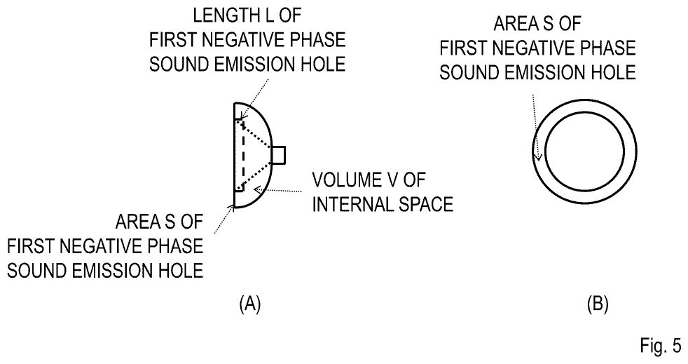

For this purpose, the collar 112 accommodates a part of the speaker unit 111 in such a manner that a path from a hole of the speaker unit 111 for emitting the negative phase sound to the first negative phase sound emission hole is short so that the negative phase sound emitted from the first negative phase sound emission hole in the front surface direction of the speaker unit 111 and the positive phase sound emitted from the speaker unit 111 in the front surface direction of the speaker unit 111 have a substantially anti-phase relationship in the predetermined frequency band in the front surface direction of the speaker unit 111, and the resonance frequency of the internal space of the collar 112 formed with respect to the speaker unit 111 is high. In order to shorten the path from the hole of the speaker unit 111 for emitting the negative phase sound to the first negative phase sound emission hole, when the speaker unit 111 is a speaker unit used for a dynamic speaker, it is sufficient if a magnet portion constituting the speaker unit 111 is not accommodated in the collar 112. In addition, in order to increase the resonance frequency of the internal space of the collar 112 formed with respect to the speaker unit 111, it is sufficient if the resonance frequency is adjusted using one or more methods of three methods: increasing an area S of the first negative phase sound emission hole, decreasing a volume V of the internal space, and shortening a length L of the first negative phase sound emission hole, in consideration of the formula described below regarding resonant frequency fu of Helmholtz resonance, and the collar 112 accommodates a part of the speaker unit 111 (see FIG. 5).

$$\begin{matrix}[ Math . 1 ] & \\ {f}_{H} = \frac{c}{2 π} \sqrt{\frac{S}{VL}} & ( 1 )\end{matrix}$$

where c represents the speed of sound.

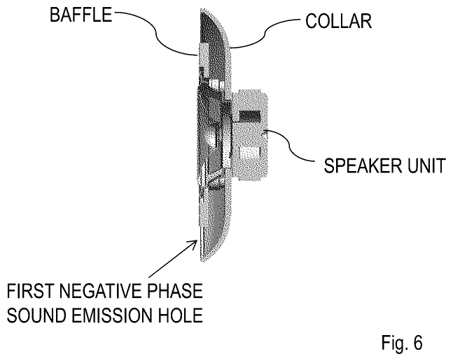

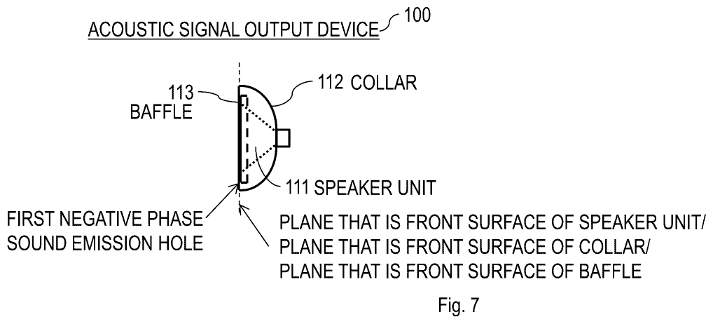

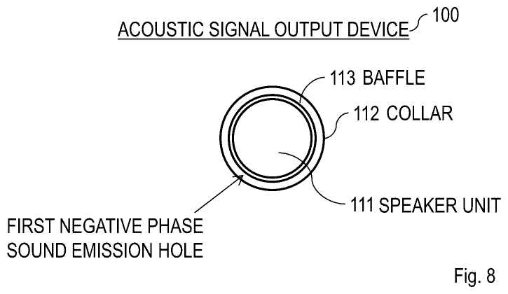

A low-frequency sound output from the acoustic signal output device 100 becomes less audible as the distance from the speaker unit increases. This is because, in a high frequency range, when the distance increases from the speaker unit, the phases of the negative phase sound and the positive phase sound are not aligned and thus do not cancel each other, whereas in a low frequency range, even when the distance from the speaker unit increases, the phases of the negative phase sound and the positive phase sound are relatively aligned and cancel each other. Therefore, a member (hereinafter, referred to as a baffle) for adjusting such that the position where the negative phase sound and the positive phase sound cancel each other in a low frequency range becomes a position far from the speaker unit is attached to the speaker unit, thereby adjusting the position desired to be the sweet spot in the front surface direction of the speaker unit (see FIG. 6). That is, a baffle 113, which is a member for preventing the negative phase sound emitted from the first negative phase sound emission hole and the positive phase sound emitted from the speaker unit 111 from canceling each other at the position desired to be the sweet spot in the front surface direction of the speaker unit 111, may be attached to the speaker unit 111. FIGS. 7 and 8 are diagrams illustrating a configuration of the acoustic signal output device 100, FIG. 7 is a diagram illustrating a state in which the acoustic signal output device 100 is viewed from the side surface direction, and FIG. 8 is a diagram illustrating a state in which the acoustic signal output device 100 is viewed from the front surface direction.

In FIG. 7, the shapes of a portion of the speaker unit 111 that emits the positive phase sound and the negative phase sound, the collar 112 and the baffle 113 have a cone shape, a bowl shape, and a plate shape, respectively.

Note that, as illustrated in FIG. 7, a plane that is the front surface of the speaker unit 111, a plane that is the front surface of the collar 112, and a plane that is the front surface of the baffle 113 are preferably substantially parallel. In FIG. 7, the three planes are substantially the same.

According to an embodiment of the present invention, it is possible to enlarge the sweet spot in a limited area such as the vicinity of the speaker unit.

### (First Modification)

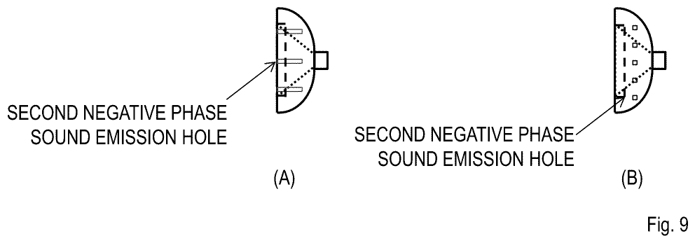

As illustrated in FIG. 9, the collar 112 may be provided with a hole (hereinafter, referred to as a second negative phase sound emission hole) different from the first negative phase sound emission hole for emitting a negative phase sound in a direction (that is, the side surface direction and the back surface direction) other than the front surface direction of the speaker unit 111. FIG. 9 is a diagram illustrating a state in which the acoustic signal output device 100 is viewed from the side surface direction. The second negative phase sound emission hole may have any shape as long as the negative phase sound is emitted to the outside of the collar 112. The shape of the second negative phase sound emission hole may be, for example, a cutout shape (see FIG. 9(A)). In addition, the second negative phase sound emission holes may be provided at regular intervals on the side surface of the collar 112 (see FIG. 9(B)).

Since the negative phase sound is emitted from the second negative phase sound emission hole to the outside of the collar 112, the sound pressure of the negative phase sound can be released in a direction other than the front surface direction of the speaker unit 111, and the characteristic as a wave of the negative phase sound emitted from the first negative phase sound emission hole changes. By suppressing cancellation of the negative phase sound and the positive phase sound in the front surface direction of the speaker unit 111, the size and directivity of the sweet spot in the front surface direction of the speaker unit 111 can be controlled.

### (Second Modification)

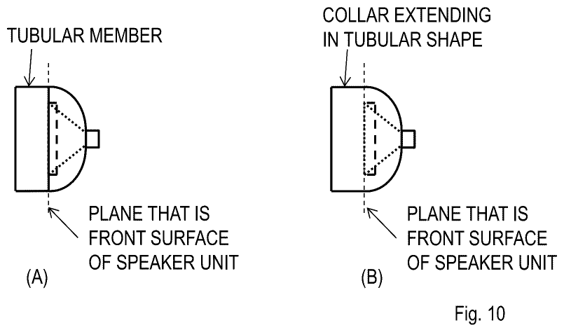

As illustrated in FIG. 10, the collar 112 may include a tubular member extending in the front surface direction of the speaker unit 111 from the plane that is the front surface of the speaker unit 111, or may have a shape extending in a tubular shape in the front surface direction of the speaker unit 111 from the plane that is the front surface of the speaker unit 111. FIG. 10 is a diagram illustrating a state in which the acoustic signal output device 100 is viewed from the side surface direction. For example, the shapes of the diaphragm of the speaker unit 111 and the collar 112 when viewed from the front surface of the speaker unit 111 are substantially circular, and the centers thereof are substantially the same, and the collar 112 may include a substantially cylindrical member extending in the front surface direction of the speaker unit 111 from the plane that is the front surface of the speaker unit 111, or may have a shape extending in a substantially cylindrical shape in the front surface direction of the speaker unit 111 from the plane that is the front surface of the speaker unit 111.

When the collar 112 as described above is used, a sound is less likely to leak out of the collar 112, so that sound leakage in the back surface direction of the speaker unit 111 can be suppressed.

### (Third Modification)

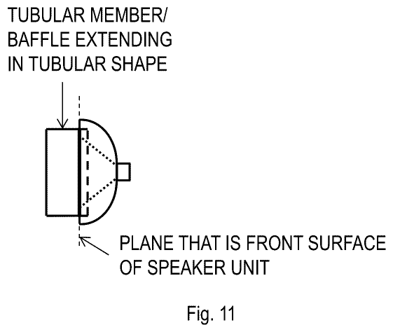

As illustrated in FIG. 11, the baffle 113 may include a tubular member extending in the front surface direction of the speaker unit 111 from the plane that is the front surface of the speaker unit 111, or may have a shape extending in a tubular shape in the front surface direction of the speaker unit 111 from the plane that is the front surface of the speaker unit 111. FIG. 11 is a diagram illustrating a state in which the acoustic signal output device 100 is viewed from the side surface direction. For example, the shapes of the diaphragm of the speaker unit 111 and the baffle 113 when viewed from the front surface of the speaker unit 111 are substantially circular, and the centers thereof are substantially the same, and the baffle 113 may include a substantially cylindrical member extending in the front surface direction of the speaker unit 111 from the plane that is the front surface of the speaker unit 111, or may have a shape extending in a substantially cylindrical shape in the front surface direction of the speaker unit 111 from the plane that is the front surface of the speaker unit 111.

When the baffle 113 as described above is used, the negative phase sound and the positive phase sound join together at a farther position in the front surface direction of the speaker unit 111, so that the sweet spot in the front surface direction of the speaker unit 111 can be located farther from the speaker unit 111.

### (Fourth Modification)

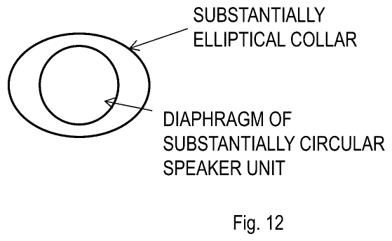

As illustrated in FIG. 12, the shape of the diaphragm of the speaker unit 111 when viewed from the front surface of the speaker unit 111 may be substantially circular, the shape of the collar 112 when viewed from the front surface of the speaker unit 111 may be substantially elliptical, and the center of the diaphragm of the speaker unit 111 and the center of the collar 112 when viewed from the front surface of the speaker unit 111 may be substantially the same. FIG. 12 is a diagram illustrating a state in which the acoustic signal output device 100 is viewed from the front surface direction.

When the collar 112 as described above is used, the size of the collar 112 when viewed from the front surface of the speaker unit 111 increases in a long diameter direction, and sound leakage in the back surface direction of the speaker unit 111 can be suppressed.

### (Fifth Modification)

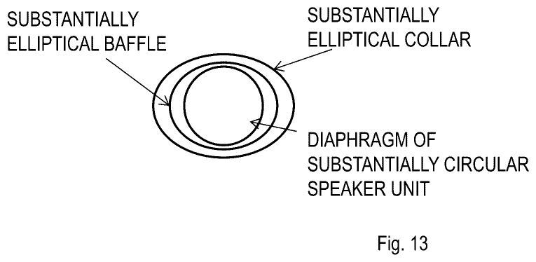

As illustrated in FIG. 13, the shape of the diaphragm of the speaker unit 111 when viewed from the front surface of the speaker unit 111 may be substantially circular, the shape of the collar 112 and the shape of the baffle 113 when viewed from the front surface of the speaker unit 111 may be substantially elliptical, and the center of the diaphragm of the speaker unit 111, the center of the collar 112, and the center of the baffle 113 when viewed from the front surface of the speaker unit 111 may be substantially the same. In addition, the long diameter direction of the collar 112 and the long diameter direction of the baffle 113 when viewed from the front surface of the speaker unit 111 may be substantially parallel. FIG. 13 is a diagram illustrating a state in which the acoustic signal output device 100 is viewed from the front surface direction.

When the collar 112 and the baffle 113 as described above are used, the sweet spot can be enlarged in the long diameter direction of the baffle 113 when viewed from the front surface of the speaker unit 111.

### (Sixth Modification)

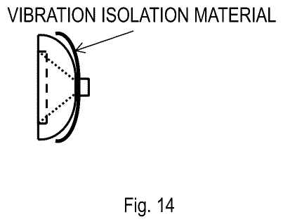

As illustrated in FIG. 14, a vibration isolation material that is a member for suppressing vibration of the collar 112 may be attached to the collar 112. FIG. 14 is a diagram illustrating a state in which the acoustic signal output device 100 is viewed from the side surface direction. As a member for suppressing vibration of the collar 112, a sound absorbing material that is a member having sound absorbing characteristics may be used.

By attaching the vibration isolation material, it is possible to prevent vibration of the collar from causing sound leakage.

### (Seventh Modification)

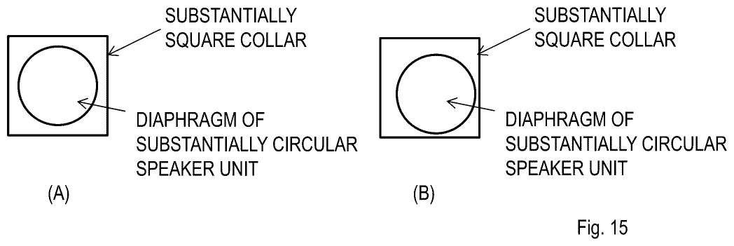

In a case where the shape of the diaphragm of the speaker unit 111 and the shape of the collar 112 when viewed from the front surface of the speaker unit 111 are substantially circular, and the center of the diaphragm of the speaker unit 111 and the center of the collar 112 when viewed from the front surface of the speaker unit 111 are substantially the same, peaks and troughs of resonance in a high frequency range and a middle frequency range in the front surface direction of the speaker unit 111 become sharp due to the characteristic as the shape of a circle, that is, the characteristic that the distance from the center of the circle to a point on the circumference is equal, and a change in loudness of a high-frequency sound or a middle-frequency sound accompanying the movement of the head of the user may be annoying. Therefore, the shape of the collar 112 when viewed from the front surface of the speaker unit 111 may be substantially square so that peaks and troughs of resonance in the high frequency range and the middle frequency range are gentle. That is, the shape of the diaphragm of the speaker unit 111 when viewed from the front surface of the speaker unit 111 is substantially circular, the shape of the collar 112 when viewed from the front surface of the speaker unit 111 is substantially square, and the center of the diaphragm of the speaker unit 111 and the center of the collar 112 when viewed from the front surface of the speaker unit 111 are substantially the same (see FIG. 15(A)). By making the shape of the collar substantially square, the distance from the center to a point on the side changes. As a result, it is possible to suppress a change in loudness of the high-frequency sound or the middle-frequency sound accompanying the movement of the head of the user, and it is possible to suppress difficulty in hearing and discomfort.

In addition, the center of the diaphragm of the speaker unit 111 and the center of the collar 112 when viewed from the front surface of the speaker unit 111 may be shifted a predetermined distance (see FIG. 15(B)). In this way, it is possible to further suppress difficulty in listening and discomfort.

Note that FIG. 15 is a diagram illustrating a state in which the acoustic signal output device 100 is viewed from the front surface direction.

### (Experimental Results)

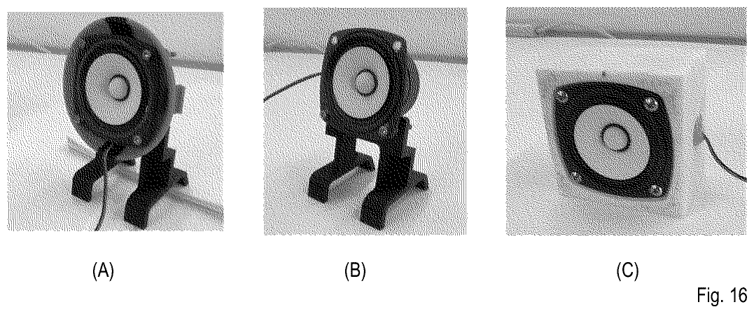

When a part of the speaker unit is accommodated in the collar as in the acoustic signal output device 100, the sweet spot can be made larger than that in the technique of Patent Literature 1. Here, an experiment for verifying the performance related to sound leakage of the acoustic signal output device 100 will be described. The performances related to sound leakage of the acoustic signal output device 100 (see FIG. 16(A)), the acoustic signal output device including only the speaker unit (see FIG. 16(B)), and the acoustic signal output device including the speaker unit and a sealed speaker box (see FIG. 16(C)) are compared and verified.

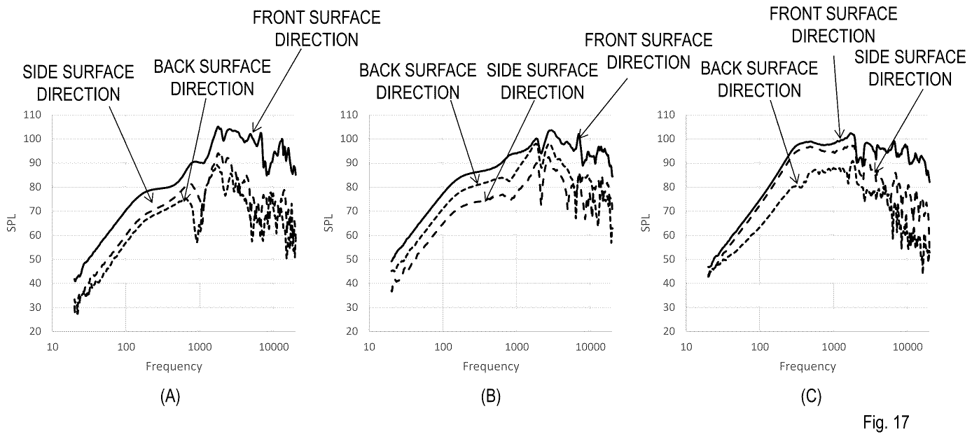

FIG. 17 illustrates experimental results. FIGS. 17(A), 17(B), and 17(C) are diagrams illustrating states of sound leakage of the acoustic signal output device 100, the acoustic signal output device including only the speaker unit, and the acoustic signal output device including the speaker unit and the sealed speaker box, respectively, and a horizontal axis represents frequency (unit is Hz), and a vertical axis represents sound pressure level ((SPL), unit is dB). As can be seen from the drawings, in the acoustic signal output device 100, when the sound pressure levels in the three directions are compared, it can be seen that sound leakage is suppressed to the same extent in the side surface direction and the back surface direction. In addition, it can be seen that sound leakage in the back surface direction is not sufficiently suppressed in the acoustic signal output device including only the speaker unit, and sound leakage in the side surface direction is not sufficiently suppressed in the acoustic signal output device including the speaker unit and the sealed speaker box. From this, it can be seen that, in the acoustic signal output device 100, a sound can be heard well in the front surface direction in which the user is present, but it is difficult to hear the sound in the side surface direction and the back surface direction, and the acoustic signal output device has preferable properties for allowing only the user to hear.

### Second Embodiment

In the first embodiment, the collar that accommodates a part of the speaker unit is used to suppress sound leakage in the side surface direction and the back surface direction, but since the speaker unit is covered from the side surface direction, resonance that causes phase inversion of the negative phase sound may occur. Therefore, in the present embodiment, a mode in which a member opened in the side surface direction is used instead of the collar will be described.

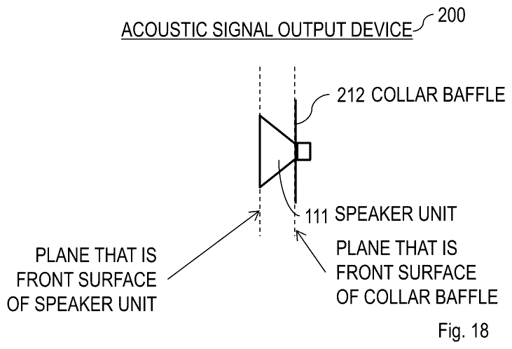

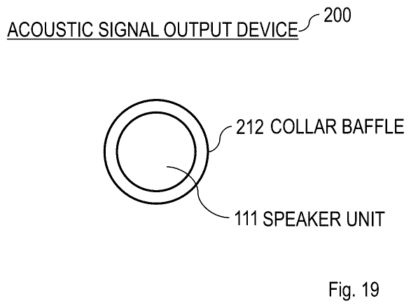

Hereinafter, the acoustic signal output device 200 will be described with reference to FIGS. 18 to 23. FIGS. 18 and 19 are diagrams illustrating a configuration of the acoustic signal output device 200, FIG. 18 is a diagram illustrating a state in which the acoustic signal output device 200 is viewed from the side surface direction, and FIG. 19 is a diagram illustrating a state in which the acoustic signal output device 200 is viewed from the front surface direction. As illustrated in FIG. 18, the acoustic signal output device 200 includes a speaker unit 111 and a collar baffle 212. The collar baffle 212 is a member attached to the speaker unit 111. Note that, in FIG. 18, the shapes of a portion of the speaker unit 111 that emits the positive phase sound and the negative phase sound and the collar baffle 212 have a cone shape and a plate shape, respectively.

Note that, as illustrated in FIG. 18, a plane that is the front surface of the speaker unit 111 and a plane that is the front surface of the collar baffle 212 are preferably substantially parallel.

The collar baffle 212 is a member for causing the negative phase sound, which is a sound emitted from the speaker unit 111 in the back surface direction of the speaker unit 111, to travel around in the front surface direction of the speaker unit 111, and the collar baffle 212 is a member having a shape in which the front surface direction and the side surface direction of the speaker unit 111 are opened so that the negative phase sound that has traveled around is emitted in the front surface direction and the side surface direction of the speaker unit 111. By using the collar baffle 212 that is a member having a shape in which the side surface direction of the speaker unit 111 is opened, it is possible to prevent resonance that causes inversion of the phase of the negative phase sound.

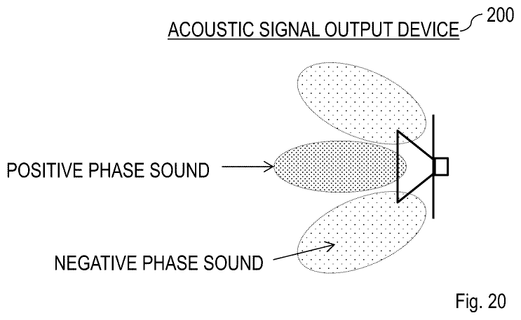

FIG. 20 is a diagram illustrating a state in which the acoustic signal output device 200 emits a positive phase sound and a negative phase sound. More specifically, the acoustic signal output device 200 emits the positive phase sound from the speaker unit 111 in the front surface direction of the speaker unit 111, and emits the negative phase sound from an opening portion between the speaker unit 111 and the collar baffle 212 in the front surface direction and the side surface direction of the speaker unit 111. At this time, in order to allow only the user in the vicinity of the speaker unit 111 to hear the sound and prevent the other users from hearing the sound, it is preferable that the positive phase sound and the negative phase sound have a substantially anti-phase relationship in the plane that is the front surface of the speaker unit 111. That is, it is preferable that the positive phase sound, which is a sound emitted from the speaker unit 111 in the front surface direction of the speaker unit 111, and the negative phase sound emitted from the opening portion between the speaker unit 111 and the collar baffle 212 in the front surface direction of the speaker unit 111 have a substantially anti-phase relationship.

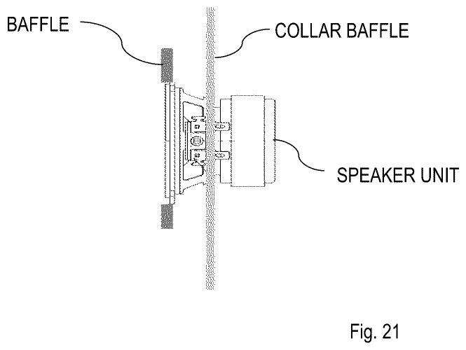

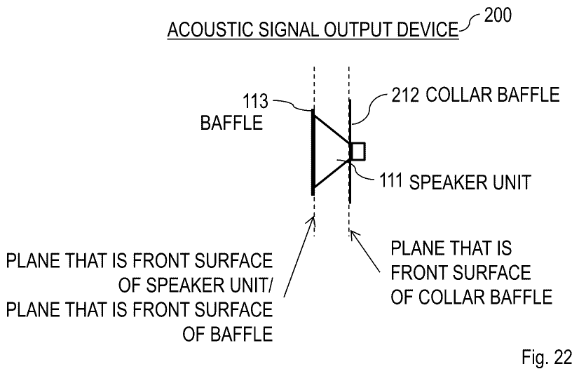

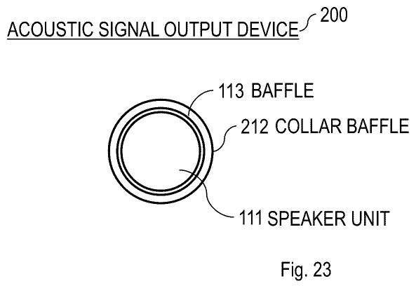

As in the first embodiment, a member (hereinafter, referred to as a baffle) for adjusting such that the position where the negative phase sound and the positive phase sound cancel each other in a low frequency range becomes a position far from the speaker unit may be attached to the speaker unit, thereby adjusting the position desired to be the sweet spot in the front surface direction of the speaker unit (see FIG. 21). That is, a baffle 113, which is a member for preventing the negative phase sound emitted from the opening portion between the speaker unit 111 and the collar baffle 212 and the positive phase sound emitted from the speaker unit 111 from canceling each other at the position desired to be the sweet spot in the front surface direction of the speaker unit 111, may be attached to the speaker unit 111. FIGS. 22 and 23 are diagrams illustrating a configuration of the acoustic signal output device 200, FIG. 22 is a diagram illustrating a state in which the acoustic signal output device 200 is viewed from the side surface direction, and FIG. 23 is a diagram illustrating a state in which the acoustic signal output device 200 is viewed from the front surface direction. At this time, it is favorable if the size of the baffle 113 when viewed from the front surface of the speaker unit 111 is smaller than the size of the collar baffle 212 when viewed from the front surface of the speaker unit 111. In addition, the size of the baffle 113 when viewed from the front surface of the speaker unit 111 may be adjusted by the user to change the position desired to be the sweet spot in the front surface direction of the speaker unit 111. Note that it is favorable if the range that can be adjusted by the user is a range that does not exceed the size of the collar baffle 212 when viewed from the front surface of the speaker unit 111.

In FIG. 22, the shapes of a portion of the speaker unit 111 that emits the positive phase sound and the negative phase sound, the collar baffle 212 and the baffle 113 have a cone shape, a plate shape, and a plate shape, respectively.

Note that, as illustrated in FIG. 22, a plane that is the front surface of the speaker unit 111, a plane that is the front surface of the collar baffle 212, and a plane that is the front surface of the baffle 113 are preferably substantially parallel. In FIG. 22, the plane that is the front surface of the speaker unit 111 and the plane that is the front surface of the baffle 113 are substantially the same.

According to an embodiment of the present invention, it is possible to enlarge the sweet spot in a limited area such as the vicinity of the speaker unit.

### (First Modification)

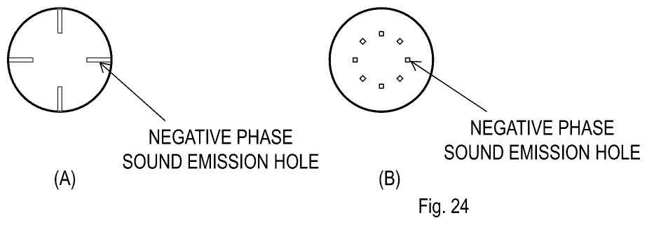

As illustrated in FIG. 24, the collar baffle 212 may be provided with a hole (hereinafter, referred to as a negative phase sound emission hole) for emitting a negative phase sound in the back surface direction of the speaker unit 111. FIG. 24 is a diagram illustrating a state in which the acoustic signal output device 200 is viewed from the back surface direction. The negative phase sound emission hole may have any shape as long as the negative phase sound is emitted to the outside of the collar baffle 212. The shape of the negative phase sound emission hole may be, for example, a cutout shape (see FIG. 24(A)). In addition, the negative phase sound emission holes may be provided at regular intervals in the collar baffle 212 (see FIG. 24(B)).

Since the negative phase sound is emitted from the negative phase sound emission hole to the outside of the collar baffle 212, the sound pressure of the negative phase sound can be released in the back surface direction of the speaker unit 111, and the characteristic as a wave of the negative phase sound emitted from the opening portion between the speaker unit 111 and the collar baffle 212 changes. By suppressing cancellation of the negative phase sound and the positive phase sound in the front surface direction of the speaker unit 111, the size and directivity of the sweet spot in the front surface direction of the speaker unit 111 can be controlled.

### (Second Modification)

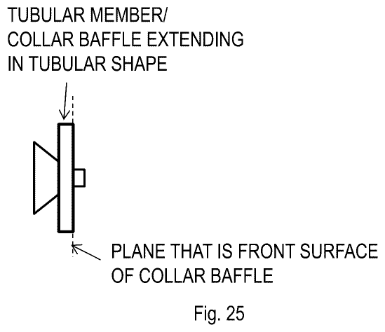

As illustrated in FIG. 25, the collar baffle 212 may include a tubular member extending in the front surface direction of the speaker unit 111 from the plane that is the front surface of the collar baffle 212, or may have a shape extending in a tubular shape in the front surface direction of the speaker unit 111 from the plane that is the front surface of the collar baffle 212. However, the length of the tube is set to such a length that the opening in the side surface direction of the speaker unit 111 is maintained. FIG. 25 is a diagram illustrating a state in which the acoustic signal output device 200 is viewed from the side surface direction. For example, the shapes of the diaphragm of the speaker unit 111 and the collar baffle 212 when viewed from the front surface of the speaker unit 111 are substantially circular, and the centers thereof are substantially the same, and the collar baffle 212 may include a substantially cylindrical member extending in the front surface direction of the speaker unit 111 from the plane that is the front surface of the collar baffle 212, or may have a shape extending in a substantially cylindrical shape in the front surface direction of the speaker unit 111 from the plane that is the front surface of the collar baffle 212.

When the collar baffle 212 as described above is used, a sound is less likely to leak out of the collar baffle 212, so that sound leakage in the back surface direction of the speaker unit 111 can be suppressed.

### (Third Modification)

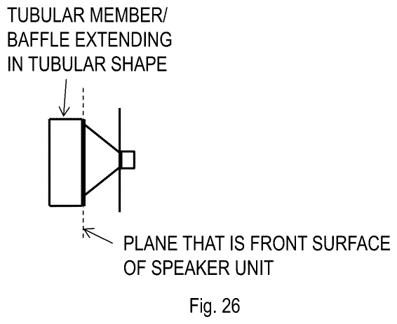

As illustrated in FIG. 26, the baffle 113 may include a tubular member extending in the front surface direction of the speaker unit 111 from the plane that is the front surface of the speaker unit 111, or may have a shape extending in a tubular shape in the front surface direction of the speaker unit 111 from the plane that is the front surface of the speaker unit 111. FIG. 26 is a diagram illustrating a state in which the acoustic signal output device 200 is viewed from the side surface direction. For example, the shapes of the diaphragm of the speaker unit 111 and the baffle 113 when viewed from the front surface of the speaker unit 111 are substantially circular, and the centers thereof are substantially the same, and the baffle 113 may include a substantially cylindrical member extending in the front surface direction of the speaker unit 111 from the plane that is the front surface of the speaker unit 111, or may have a shape extending in a substantially cylindrical shape in the front surface direction of the speaker unit 111 from the plane that is the front surface of the speaker unit 111.

When the baffle 113 as described above is used, the negative phase sound and the positive phase sound join together at a farther position in the front surface direction of the speaker unit 111, so that the sweet spot in the front surface direction of the speaker unit 111 can be located farther from the speaker unit 111.

### (Fourth Modification)

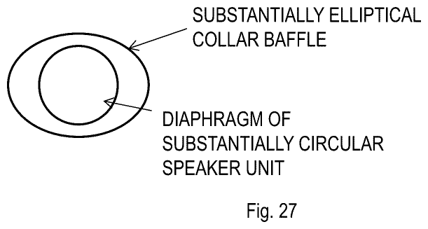

As illustrated in FIG. 27, the shape of the diaphragm of the speaker unit 111 when viewed from the front surface of the speaker unit 111 may be substantially circular, the shape of the collar baffle 212 when viewed from the front surface of the speaker unit 111 may be substantially elliptical, and the center of the diaphragm of the speaker unit 111 and the center of the collar baffle 212 when viewed from the front surface of the speaker unit 111 may be substantially the same. FIG. 27 is a diagram illustrating a state in which the acoustic signal output device 200 is viewed from the front surface direction.

When the collar baffle 212 as described above is used, the size of the collar baffle 212 when viewed from the front surface of the speaker unit 111 increases in a long diameter direction, and sound leakage in the back surface direction of the speaker unit 111 can be suppressed.

### (Fifth Modification)

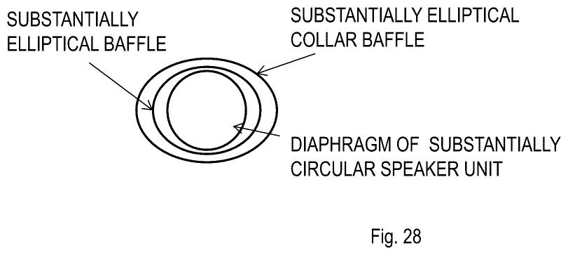

As illustrated in FIG. 28, the shape of the diaphragm of the speaker unit 111 when viewed from the front surface of the speaker unit 111 may be substantially circular, the shape of the collar baffle 212 and the shape of the baffle 113 when viewed from the front surface of the speaker unit 111 may be substantially elliptical, and the center of the diaphragm of the speaker unit 111, the center of the collar baffle 212, and the center of the baffle 113 when viewed from the front surface of the speaker unit 111 may be substantially the same. In addition, the long diameter direction of the collar baffle 212 and the long diameter direction of the baffle 113 when viewed from the front surface of the speaker unit 111 may be substantially parallel. FIG. 28 is a diagram illustrating a state in which the acoustic signal output device 200 is viewed from the front surface direction.

When the collar baffle 212 and the baffle 113 as described above are used, the sweet spot can be enlarged in the long diameter direction of the baffle 113 when viewed from the front surface of the speaker unit 111.

### (Sixth Modification)

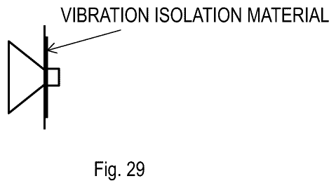

As illustrated in FIG. 29, a vibration isolation material that is a member for suppressing vibration of the collar baffle 212 may be attached to the collar baffle 212. FIG. 29 is a diagram illustrating a state in which the acoustic signal output device 200 is viewed from the side surface direction. As a member for suppressing vibration of the collar baffle 212, a sound absorbing material that is a member having sound absorbing characteristics may be used.

By attaching the vibration isolation material, it is possible to prevent vibration of the collar baffle from causing sound leakage.

### (Seventh Modification)

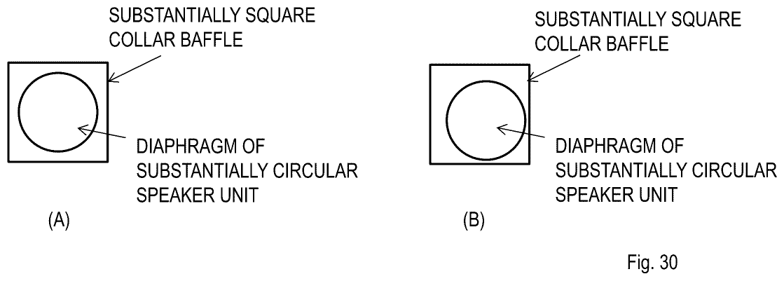

As in the seventh modification of the first embodiment, the shape of the diaphragm of the speaker unit 111 when viewed from the front surface of the speaker unit 111 may be substantially circular, the shape of the collar baffle 212 when viewed from the front surface of the speaker unit 111 may be substantially square, and the center of the diaphragm of the speaker unit 111 and the center of the collar baffle 212 when viewed from the front surface of the speaker unit 111 may be substantially the same (see FIG. 30(A)). By making the shape of the collar substantially square, the distance from the center to a point on the side changes. As a result, it is possible to suppress a change in loudness of the high-frequency sound or the middle-frequency sound accompanying the movement of the head of the user, and it is possible to suppress difficulty in hearing and discomfort.

In addition, the center of the diaphragm of the speaker unit 111 and the center of the collar baffle 212 when viewed from the front surface of the speaker unit 111 may be shifted a predetermined distance (see FIG. 30(B)). In this way, it is possible to further suppress difficulty in listening and discomfort.

Note that FIG. 30 is a diagram illustrating a state in which the acoustic signal output device 200 is viewed from the front surface direction.

### (Experimental Results)

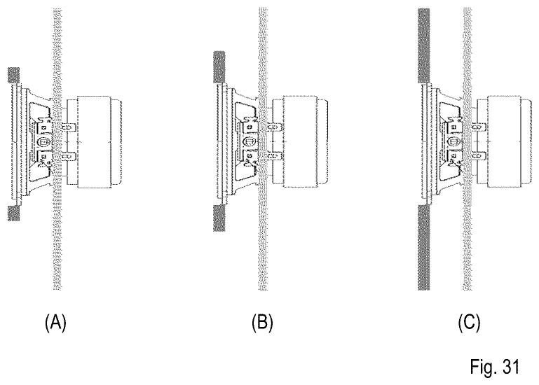

Here, an experiment for verifying the performance related to sound leakage of the acoustic signal output device 200 will be described. The performances related to sound leakage of the acoustic signal output device 200 having a small baffle size (see FIG. 31(A)), the acoustic signal output device 200 having a medium baffle size (see FIG. 31(B)), and the acoustic signal output device 200 having a large baffle size (see FIG. 31(C)) are compared and verified. The shapes of the baffles and the collar baffles of the acoustic signal output devices 200 when viewed from the front surface of the speaker unit are square. Here, the baffle size and the collar baffle size are each a length of one side of a square, and the baffle size of each of the acoustic signal output devices 200 is 9 cm, 13 cm, and 17 cm, and the collar baffle sizes are all 17 cm.

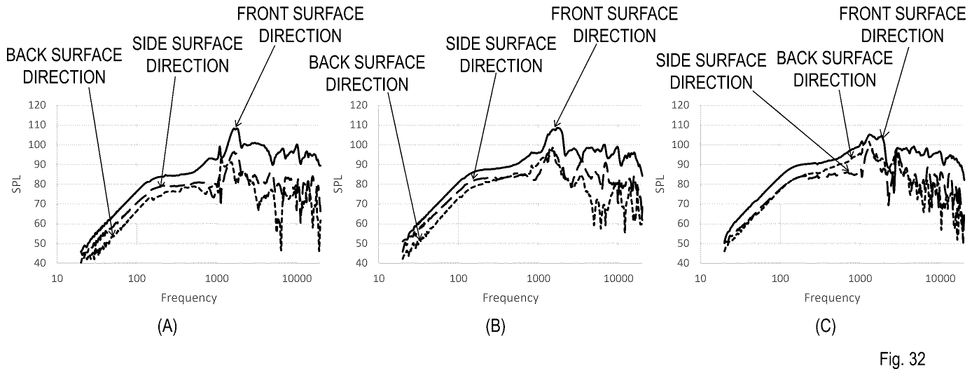

FIG. 32 illustrates experimental results. FIGS. 32(A), 32(B), and 32(C) are diagrams illustrating states of sound leakage of the acoustic signal output device 200 having a small baffle size, the acoustic signal output device 200 having a medium baffle size, and the acoustic signal output device 200 having a large baffle size, respectively, and a horizontal axis represents frequency (unit is Hz), and a vertical axis represents sound pressure level ((SPL), unit is dB). As can be seen by comparing the three drawings, the size of the baffle is preferably smaller than the size of the collar baffle in order to reduce sound leakage in the side surface direction and the back surface direction.

### Third Embodiment

In the first embodiment, since only one speaker unit is used, the sweet spot may be narrow. Therefore, in the present embodiment, a mode using a plurality of speaker units will be described.

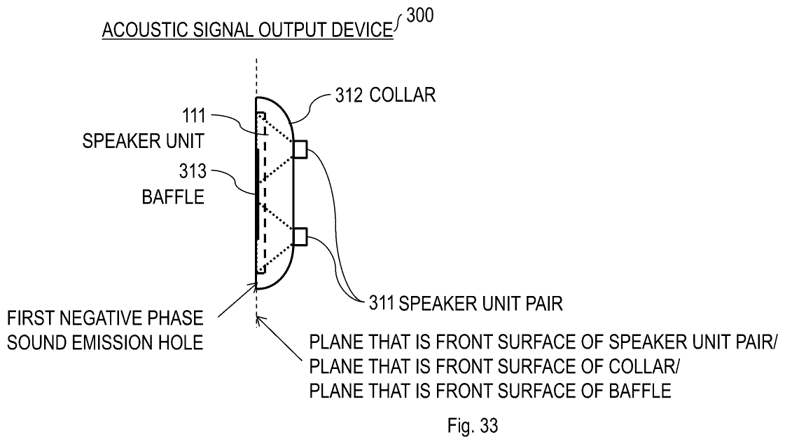

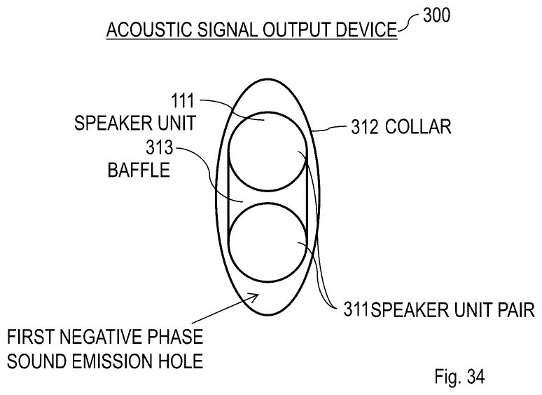

Hereinafter, the acoustic signal output device 300 will be described with reference to FIGS. 33 to 36. FIGS. 33 and 34 are diagrams illustrating a configuration of the acoustic signal output device 300, FIG. 33 is a diagram illustrating a state in which the acoustic signal output device 300 is viewed from the side surface direction, and FIG. 34 is a diagram illustrating a state in which the acoustic signal output device 300 is viewed from the front surface direction. As illustrated in FIG. 33, the acoustic signal output device 300 includes a speaker unit pair 311 including two speaker units 111, a collar 312, and a baffle 313. The acoustic characteristics of the two speaker units 111 constituting the speaker unit pair 311 are substantially the same, and the same acoustic signal is input. In addition, the front surfaces of the two speaker units 111 constituting the speaker unit pair 311 are substantially on the same plane, for example. The collar 312 is a housing that accommodates a part of the speaker unit pair 311. Note that, in FIG. 33, a part of the speaker unit 111 (a part accommodated in the collar 312) is not visible from the side surface direction, and thus is indicated by the dotted lines. In addition, in FIG. 33, the shapes of a portion of the speaker unit 111 that emits the positive phase sound and the negative phase sound, the collar 312 and the baffle 313 have a cone shape, an elongated bowl shape, and a plate shape, respectively.

Note that, as illustrated in FIG. 33, a plane that is the front surface of the speaker unit pair 311, a plane that is the front surface of the collar 312, and a plane that is the front surface of the baffle 313 are preferably substantially parallel. In FIG. 33, the three planes are substantially the same.

The collar 312 is a housing for causing the negative phase sound, which is a sound emitted from the two speaker units 111 constituting the speaker unit pair 311 in the back surface direction of the speaker unit pair 311, to travel around in the front surface direction of the speaker unit pair 311, and the collar 312 is provided with a hole (hereinafter, referred to as a first negative phase sound emission hole) for emitting the negative phase sound that has traveled around in the front surface direction of the speaker unit pair 311. Note that, in FIG. 33, since the first negative phase sound emission hole is not visible from the side surface direction, the first negative phase sound emission hole is indicated by the broken line.

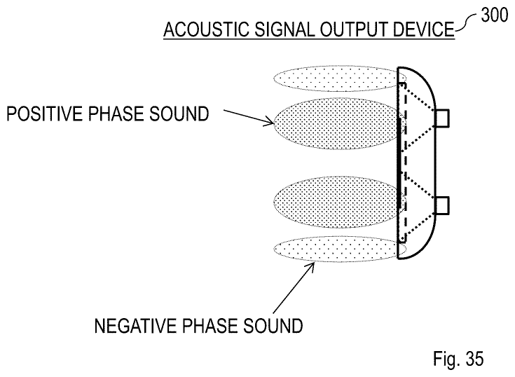

FIG. 35 is a diagram illustrating a state in which the acoustic signal output device 300 emits a positive phase sound and a negative phase sound. More specifically, the acoustic signal output device 300 emits the positive phase sound from the speaker unit 111 in the front surface direction of the speaker unit pair 311, and emits the negative phase sound from the first negative phase sound emission hole in the front surface direction of the speaker unit pair 311. At this time, in order to allow only the user in the vicinity of the speaker unit pair 311 to hear the sound and prevent the other users from hearing the sound, it is preferable that the positive phase sound and the negative phase sound have a substantially anti-phase relationship in the plane that is the front surface of the speaker unit 111. That is, it is preferable that the positive phase sound, which is a sound emitted from the speaker unit 111 in the front surface direction of the speaker unit pair 311, and the negative phase sound emitted from the first negative phase sound emission hole in the front surface direction of the speaker unit pair 311 have a substantially anti-phase relationship. More specifically, in a predetermined frequency band in the front surface direction of the speaker unit pair 311, it is preferable that the positive phase sound emitted from the speaker unit 111 in the front surface direction of the speaker unit pair 311 and the negative phase sound emitted from the first negative phase sound emission hole in the front surface direction of the speaker unit pair 311 have a substantially anti-phase relationship. Here, the predetermined frequency band is desirably a band lower than or equal to a frequency (hereinafter, referred to as a resonance frequency) at which resonance in the internal space of the collar 312 formed with respect to the speaker unit pair 311 and the baffle 313 occurs.

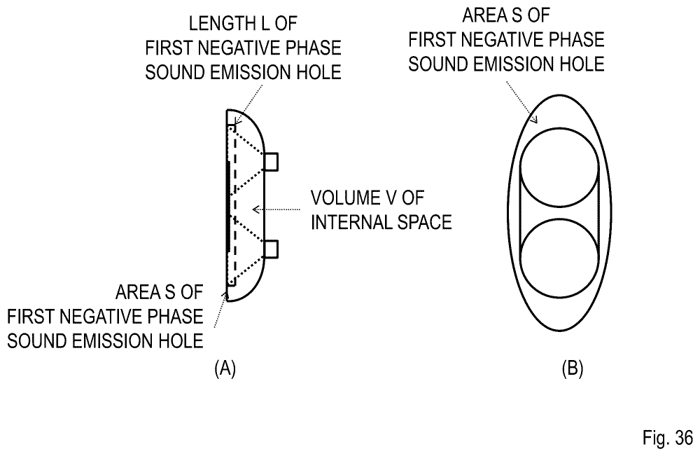

For this purpose, the collar 312 accommodates a part of the speaker unit 111 in such a manner that a path from a hole of each speaker unit 111 constituting the speaker unit pair 311 for emitting the negative phase sound to the first negative phase sound emission hole is short so that the negative phase sound emitted from the first negative phase sound emission hole in the front surface direction of the speaker unit pair 311 and the positive phase sound emitted from the speaker unit 111 in the front surface direction of the speaker unit pair 311 have a substantially anti-phase relationship in the predetermined frequency band in the front surface direction of the speaker unit pair 311, and the resonance frequency of the internal space of the collar 312 formed with respect to the speaker unit pair 311 and the baffle 313 is high. In order to shorten the path from the hole of the speaker unit 111 for emitting the negative phase sound to the first negative phase sound emission hole, when the speaker unit 111 is a speaker unit used for a dynamic speaker, it is sufficient if a magnet portion constituting the speaker unit 111 is not accommodated in the collar 312. In addition, in order to increase the resonance frequency of the internal space of the collar 312 formed with respect to the speaker unit pair 311 and the baffle 313, as in the first embodiment, it is sufficient if the resonance frequency is adjusted using one or more methods of three methods: increasing an area S of the first negative phase sound emission hole, decreasing a volume V of the internal space, and shortening a length L of the first negative phase sound emission hole, in consideration of Formula (1) regarding resonant frequency f_{H} of Helmholtz resonance, and the collar 312 accommodates a part of the speaker unit pair 311 (see FIG. 36).

The baffle 313, which is a member for preventing the negative phase sound emitted from the first negative phase sound emission hole and the positive phase sound, which is a sound emitted from the two speaker units 111 constituting the speaker unit pair 311 in the front surface direction of the speaker unit pair 311 from canceling each other at the position desired to be the sweet spot in the front surface direction of the speaker unit pair 311, is attached to the speaker unit pair 311. In addition, the baffle 313 is attached to the speaker unit pair 311 in order to set an area between the speaker units 111 in the front surface direction constituting the speaker unit pair 311 as a sweet spot. Therefore, for example, the baffle 313 is attached to the speaker unit pair 311 in such a manner as to connect opposing sides of one speaker unit 111 and the other speaker unit 111 constituting the speaker unit pair 311. As a result, the baffle 313 is attached to the side of the speaker unit 111 facing the other speaker unit 111, but the baffle 313 is not attached to the side opposite to the side facing the other speaker unit 111, and it is possible to reduce sound leakage in the side surface direction and the back surface direction as in the acoustic signal output device 100. Note that, since the negative phase sound travels around in the front surface direction of the speaker unit pair 311 by the collar 312, sound leakage in a high frequency range in the back surface direction of the speaker unit pair 311 can also be reduced.

According to an embodiment of the present invention, it is possible to enlarge the sweet spot in a limited area such as the vicinity of the speaker unit. In addition, it is possible to set an area between the speaker units in the front surface direction where it is difficult to hear in Patent Literature 1 as a sweet spot.

### (First Modification)

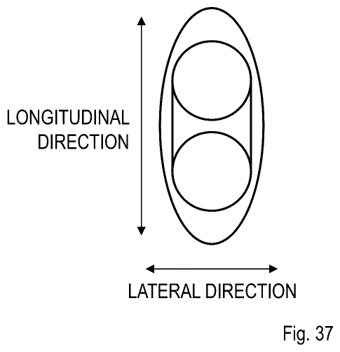

Hereinafter, a direction connecting the two speaker units 111 constituting the speaker unit pair 311 when viewed from the front surface of the speaker unit pair 311 is referred to as a longitudinal direction of the baffle 313, and a direction perpendicular to the direction connecting the two speaker units 111 constituting the speaker unit pair 311 when viewed from the front surface of the speaker unit pair 311 is referred to as a lateral direction of the baffle 313 (see FIG. 37).

As described above, the baffle 313 is attached to the speaker unit pair 311 in order to set an area between the speaker units 111 in the front surface direction constituting the speaker unit pair 311 as a sweet spot. The size of the sweet spot between the speaker units 111 in the front surface direction constituting the speaker unit pair 311 depends on the length in the longitudinal direction and the length in the lateral direction of the baffle 313. That is, increasing the length of the baffle 313 in the longitudinal direction increases the size of the sweet spot in the longitudinal direction, and increasing the length of the baffle 313 in the lateral direction increases the size of the sweet spot in the lateral direction. Therefore, both the length of the baffle 313 in the longitudinal direction and the length of the baffle 313 in the lateral direction may be determined according to the size of the area desired to be the sweet spot between the speaker units 111 in the front surface direction constituting the speaker unit pair 311.

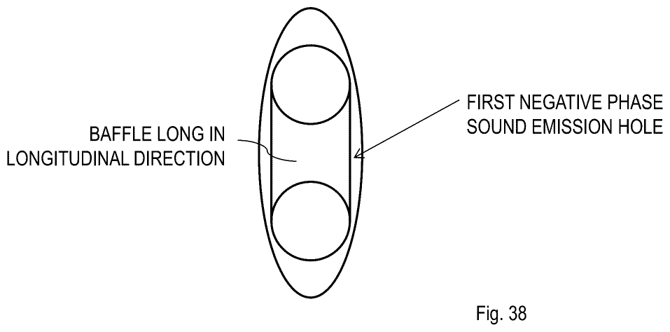

As illustrated in FIG. 38, the length of the baffle 313 in the longitudinal direction connecting the two speaker units 111 is made longer, and the two speaker units 111 are installed apart from each other, whereby the sweet spot in the front surface direction of the speaker unit pair 311 can be enlarged.

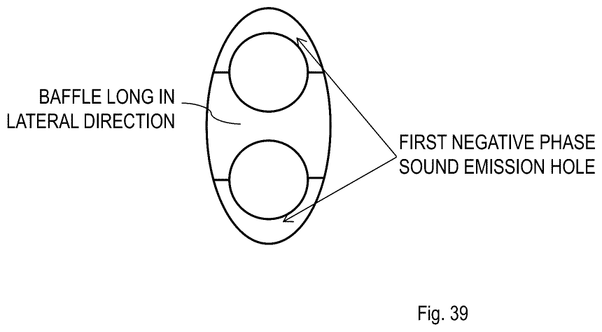

In addition, as illustrated in FIG. 39, the baffle 313 is installed such that the length of the baffle 313 in the lateral direction is made longer so that the collar 312 and the baffle 313 are in contact with each other, whereby the sweet spot in the front surface direction of the speaker unit pair 311 can be enlarged. At this time, the sweet spot can also be positioned farther from the front surface of the speaker unit pair 311.

### (Second Modification)

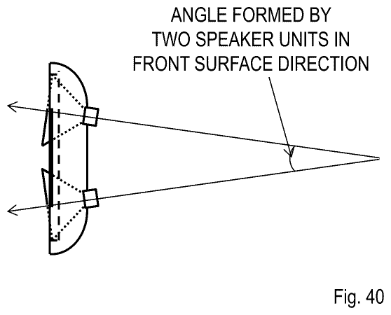

As illustrated in FIG. 40, the speaker units 111 may be disposed such that the planes that are the front surfaces of the speaker units 111 constituting the speaker unit pair 311 are not on the same plane. In the example of FIG. 40, the two speaker units 111 are disposed such that the angle formed by the two speaker units 111 in the front surface direction is an acute angle smaller than 45 degrees.

### (Third Modification)

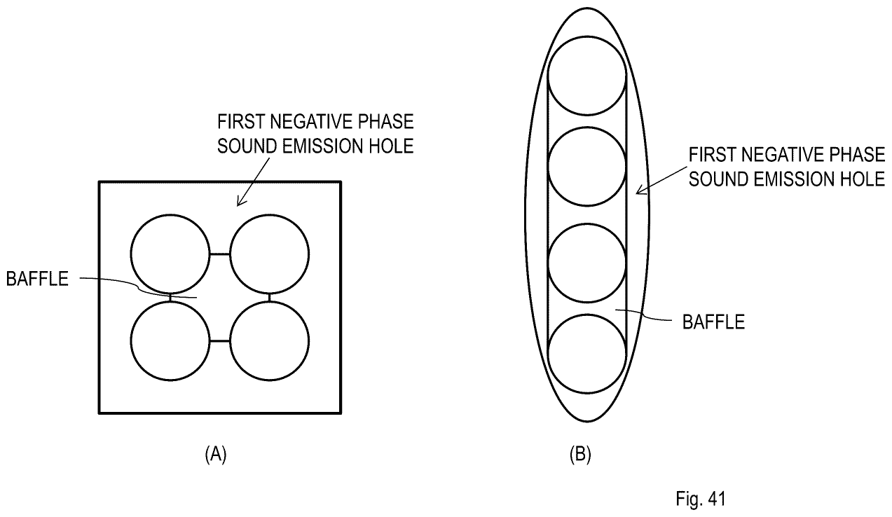

As illustrated in FIG. 41, the number of speaker units included in the acoustic signal output device 300 may be, for example, four.

As in the modifications described above, the size of the sweet spot can be adjusted by adjusting the length of the baffle 313 in the longitudinal direction, the length of the baffle 313 in the lateral direction, the angle formed by the two speaker units 111 in the front surface direction, and the number of speaker units included in the acoustic signal output device 300.

### Fourth Embodiment

In a case where a stereo acoustic signal is reproduced using two acoustic signal output devices 100, the range in which the sound of each channel can be heard is the same as the sweet spot of the acoustic signal output device 100, so that the size of the sweet spot may not be sufficient. In addition, in a case where a stereo acoustic signal is reproduced using two acoustic signal output devices 300, four speaker units are required, and thus, a place required for installation becomes large. Therefore, in the present embodiment, a stereo acoustic signal reproduction mode using one acoustic signal output device 300 in which the sweet spot is larger than that in a case where two acoustic signal output devices 100 are used will be described.

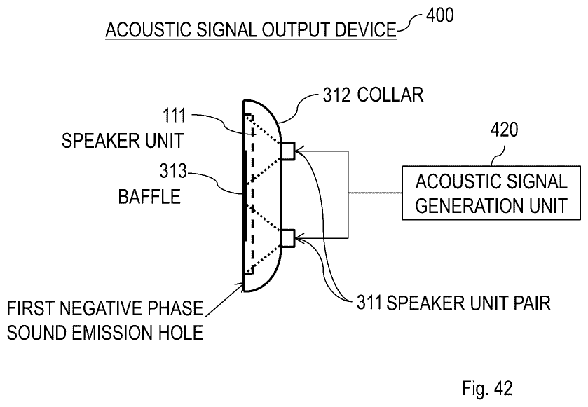

Hereinafter, the acoustic signal output device 400 will be described with reference to FIG. 42. FIG. 42 is a diagram illustrating a configuration of the acoustic signal output device 400. As illustrated in FIG. 42, the acoustic signal output device 400 includes a speaker unit pair 311 including two speaker units 111, a collar 312, a baffle 313, and an acoustic signal generation unit 420. That is, the acoustic signal output device 400 is different from the acoustic signal output device 300 only in that the acoustic signal generation unit 420 is further included. Note that the acoustic signal generation unit 420 can be configured using, for example, a general-purpose computer. The acoustic signal generation unit 420 is achieved by a general-purpose computer by storing a program for achieving the function of the acoustic signal generation unit 420 in an external storage device, a ROM, or the like, reading the program and data necessary for processing the program in RAM as necessary, and appropriately processing the program using a CPU. That is, the acoustic signal generation unit 420 may include processing circuitry.

The acoustic signal generation unit 420 is a component that receives a right-channel acoustic signal and a left-channel acoustic signal, generates a first output acoustic signal and a second output acoustic signal using the right-channel acoustic signal and the left-channel acoustic signal, outputs the first output acoustic signal to one speaker unit 111 constituting the speaker unit pair 311, and outputs the second output acoustic signal to the other speaker unit 111 constituting the speaker unit pair 311. The acoustic signal generation unit 420 may output the input right-channel acoustic signal and left-channel acoustic signal as they are without performing signal processing. That is, the first output acoustic signal is the right-channel acoustic signal, and the second output acoustic signal is the left-channel acoustic signal. In this way, in a general stereo sound source, since the correlation between channels is high in a low frequency range, the sweet spot is enlarged, and sound leakage at a farther position in the front surface direction and sound leakage in the side surface direction and the back surface direction are suppressed. On the other hand, in a high frequency range, the correlation between channels is not as high as in a low frequency range. However, since the high-frequency sound has larger straightness than the low-frequency sound, sound leakage in the side surface direction and the back surface direction is suppressed.

In addition, the acoustic signal generation unit 420 may generate the first output acoustic signal and the second output acoustic signal as acoustic signals that increase the size of the sweet spot from the input right-channel acoustic signal and left-channel acoustic signal and output the first output acoustic signal and the second output acoustic signal. For this purpose, the acoustic signal generation unit 420 generates the first output acoustic signal and the second output acoustic signal by performing signal processing of mixing the input right-channel acoustic signal and left-channel acoustic signal to obtain a new acoustic signal. For example, r (where, r satisfies 0<r<1) is set as a mixing coefficient, and the acoustic signal generation unit 420 generates, as the first output acoustic signal, an acoustic signal obtained by mixing the right-channel acoustic signal and the left-channel acoustic signal at a ratio of r:1−r, and generates, as the second output acoustic signal, an acoustic signal obtained by mixing the right-channel acoustic signal and the left-channel acoustic signal at a ratio of 1−r:r. That is, the first output acoustic signal and the second output acoustic signal are generated by first output acoustic signal=right-channel acoustic signal×r+left-channel acoustic signal×(1−r) and second output acoustic signal=right-channel acoustic signal×(1−r)+left-channel acoustic signal×r. Note that the mixing coefficient r may be a frequency-dependent value, and a different mixing coefficient may be used for each frequency.

According to an embodiment of the present invention, it is possible to enlarge the sweet spot in a limited area such as the vicinity of the speaker unit. By receiving the right-channel acoustic signal and the left-channel acoustic signal, it is possible to enlarge the sweet spot.

### Fifth Embodiment

As described in the first embodiment, in a low frequency range, even at a distance from the speaker unit, the phases of the negative phase sound and the positive phase sound are relatively aligned and cancel each other, so that the low-frequency sound may be felt to be weak. Therefore, in the present embodiment, a mode using a woofer which is a speaker unit for low-frequency reproduction and a tweeter which is a speaker unit for high-frequency reproduction will be described.

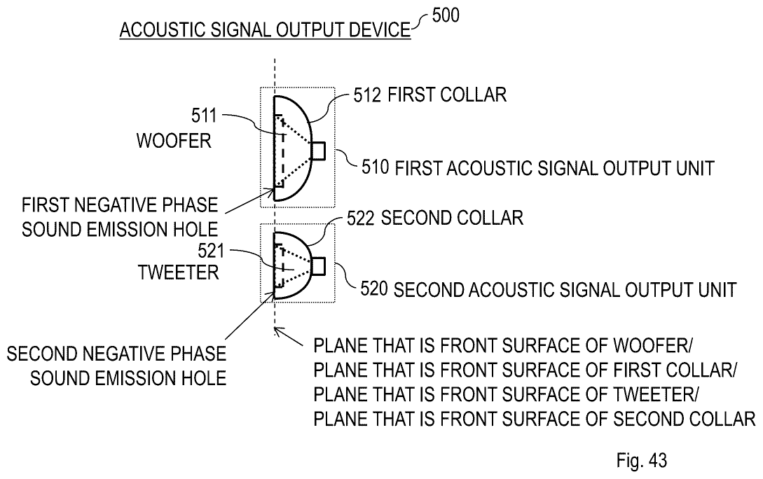

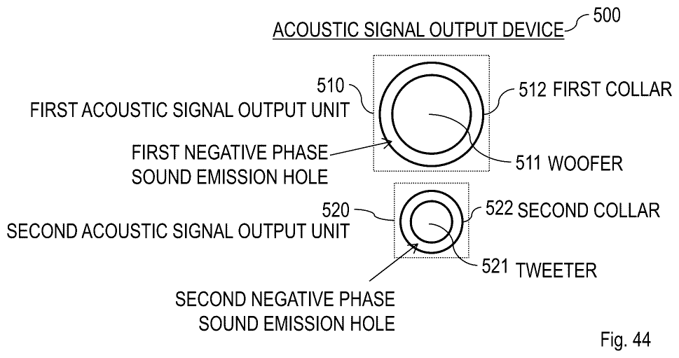

Hereinafter, the acoustic signal output device 500 will be described with reference to FIGS. 43 to 45. FIGS. 43 and 44 are diagrams illustrating a configuration of the acoustic signal output device 500, FIG. 43 is a diagram illustrating a state in which the acoustic signal output device 500 is viewed from the side surface direction, and FIG. 44 is a diagram illustrating a state in which the acoustic signal output device 500 is viewed from the front surface direction. As illustrated in FIG. 43, the acoustic signal output device 500 includes a first acoustic signal output unit 510 and a second acoustic signal output unit 520. The first acoustic signal output unit 510 includes a woofer 511 that is a speaker unit for reproducing low-frequency sounds and a first collar 512. The first collar 512 is a housing that accommodates a part of the woofer 511. In addition, the second acoustic signal output unit 520 includes a tweeter 521 that is a speaker unit for reproducing high-frequency sounds and a second collar 522. The second collar 522 is a housing that accommodates a part of the tweeter 521. Note that, in FIG. 43, a part of the woofer 511 (a part accommodated in the first collar 512) and a part of the tweeter 521 (a part accommodated in the second collar 522) are both invisible from the side surface direction, and are indicated by the dotted lines. In addition, in FIG. 43, the shapes of a portion of the woofer 511 that emits the positive phase sound and the negative phase sound and the first collar 512 have a cone shape and a bowl shape, respectively. Similarly, the shapes of a portion of the tweeter 521 that emits the positive phase sound and the negative phase sound and the second collar 522 have a cone shape and a bowl shape, respectively.

Note that, as illustrated in FIG. 43, a plane that is the front surface of the woofer 511 and a plane that is the front surface of the first collar 512 are preferably substantially parallel. Similarly, as illustrated in FIG. 43, a plane that is the front surface of the tweeter 521 and a plane that is the front surface of the second collar 522 are also preferably substantially parallel. In FIG. 43, the four planes are substantially the same.

The first collar 512 is a housing for causing the negative phase sound (hereinafter, referred to as a first negative phase sound), which is a sound emitted from the woofer 511 in the back surface direction of the woofer 511, to travel around in the front surface direction of the woofer 511, and the first collar 512 is provided with a hole (hereinafter, referred to as a first negative phase sound emission hole) for emitting the first negative phase sound that has traveled around in the front surface direction of the woofer 511. In addition, the second collar 522 is a housing for causing the negative phase sound (hereinafter, referred to as a second negative phase sound), which is a sound emitted from the tweeter 521 in the back surface direction of the tweeter 521, to travel around in the front surface direction of the tweeter 521, and the second collar 522 is provided with a hole (hereinafter, referred to as a second negative phase sound emission hole) for emitting the second negative phase sound that has traveled around in the front surface direction of the tweeter 521. Note that, in FIG. 43, since the first negative phase sound emission hole and the second negative phase sound emission hole are not visible from the side surface direction, the first negative phase sound emission hole and the second negative phase sound emission hole are indicated by the broken line.

The first collar 512 accommodates a part of the woofer 511 in such a manner that a path from a hole of the woofer 511 for emitting the first negative phase sound to the first negative phase sound emission hole is short so that the first negative phase sound emitted from the first negative phase sound emission hole and the sound (hereinafter, referred to as a first positive phase sound) emitted from the woofer 511 in the front surface direction of the woofer 511 have a substantially anti-phase relationship in the predetermined frequency band in the front surface direction of the woofer 511, and the frequency at which resonance of the internal space of the first collar 512 formed with respect to the woofer 511 occurs (hereinafter, resonance frequency) is high. Note that the predetermined frequency band is desirably a band lower than or equal to the resonance frequency of the internal space of the first collar 512 formed with respect to the woofer 511. In order to shorten the path from the hole of the woofer 511 for emitting the first negative phase sound to the first negative phase sound emission hole, when the woofer 511 is a woofer used for a dynamic speaker, it is sufficient if a magnet portion constituting the woofer 511 is not accommodated in the first collar 512. In addition, in order to increase the resonance frequency of the internal space of the first collar 512 formed with respect to the woofer 511, it is sufficient if the resonance frequency is adjusted using one or more methods of three methods: increasing an area S of the first negative phase sound emission hole, decreasing a volume V of the internal space, and shortening a length L of the first negative phase sound emission hole, in consideration of Formula (1) regarding resonant frequency f_{H} of Helmholtz resonance, and the first collar 512 accommodates a part of the woofer 511. In addition, the second collar 522 accommodates a part of the tweeter 521 in such a manner that a path from a hole of the tweeter 521 for emitting the second negative phase sound to the second negative phase sound emission hole is short so that the second negative phase sound emitted from the second negative phase sound emission hole and the sound (hereinafter, referred to as a second positive phase sound) emitted from the tweeter 521 in the front surface direction of the tweeter 521 have a substantially anti-phase relationship in the predetermined frequency band in the front surface direction of the tweeter 521, and the frequency at which resonance of the internal space of the second collar 522 formed with respect to the tweeter 521 occurs (hereinafter, resonance frequency) is high. Note that the predetermined frequency band is desirably a band lower than or equal to the resonance frequency of the internal space of the second collar 522 formed with respect to the tweeter 521. In order to shorten the path from the hole of the tweeter 521 for emitting the second negative phase sound to the second negative phase sound emission hole, when the tweeter 521 is a tweeter used for a dynamic speaker, it is sufficient if a magnet portion constituting the tweeter 521 is not accommodated in the second collar 522. In addition, in order to increase the resonance frequency of the internal space of the second collar 522 formed with respect to the tweeter 521, it is sufficient if the resonance frequency is adjusted using one or more methods of three methods: increasing an area S of the second negative phase sound emission hole, decreasing a volume V of the internal space, and shortening a length L of the second negative phase sound emission hole, in consideration of Formula (1) regarding resonant frequency f of Helmholtz resonance, and the second collar 522 accommodates a part of the tweeter 521.

The second acoustic signal output unit 520 is installed near the user's ear in order to suppress sound leakage. For example, there are two second acoustic signal output units 520, one for emitting a right-channel acoustic signal and the other for emitting a left-channel acoustic signal. At this time, it is sufficient if the second acoustic signal output unit 520 for emitting the right-channel acoustic signal is installed near the right ear of the user, and the second acoustic signal output unit 520 for emitting the left-channel acoustic signal is installed near the left ear of the user.

As in the first embodiment, a member (hereinafter, referred to as a baffle) for adjusting such that the position where the negative phase sound and the positive phase sound cancel each other in a low frequency range becomes a position far from the woofer may be attached to the woofer, thereby adjusting the position desired to be the sweet spot in the front surface direction of the woofer. That is, a first baffle (not illustrated), which is a member for preventing the first negative phase sound emitted from the first negative phase sound emission hole and the first positive phase sound emitted from the woofer 511 from canceling each other at the position desired to be the sweet spot in the front surface direction of the woofer 511, may be attached to the woofer 511.

In addition, similarly to the woofer, a baffle may be attached to the tweeter in order to suppress sound leakage in the side surface direction and the back surface direction. That is, a second baffle (not illustrated), which is a member for suppressing sound leakage in the side surface direction and the back surface direction of the tweeter 521, may be attached to the tweeter 521.

Note that when a speaker unit that reproduces a low-frequency sound of about 300 Hz is used as the woofer 511, the first acoustic signal output unit 510 including the first baffle can sufficiently obtain a low-frequency sound in the vicinity of the woofer 511 by increasing a reproduction voltage. In addition, sound leakage can be suppressed by using a speaker unit having an aperture of about 30 mm as the tweeter 521 and installing the second acoustic signal output unit 520 including the second baffle at a position close to the user's ear.

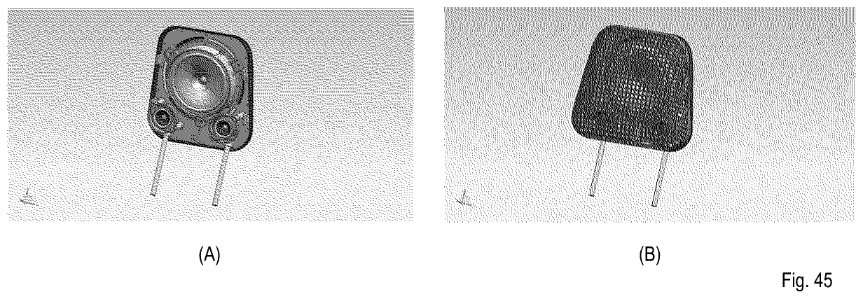

FIG. 45 is an example of a vehicular acoustic signal output device 500 installed in a headrest of a seat of a vehicle. FIG. 45(A) illustrates a state of being exposed, and FIG. 45(B) illustrates a state of being covered. As illustrated in FIG. 45, the vehicular acoustic signal output device 500 includes a large woofer disposed at the center and small tweeters disposed at the lower right and lower left of the woofer, respectively. With such a disposition mode, a large woofer is present immediately behind the user's head, so that cancellation of a low-frequency sound is suppressed, and the user can more easily hear the low-frequency sound.

According to an embodiment of the present invention, it is possible to enlarge the sweet spot in a limited area such as the vicinity of the speaker unit. By adopting a two-way configuration of a woofer and a tweeter, it is possible to enhance the low frequency range using the woofer. Specifically, by driving the woofer for reproducing a low-frequency sound that is substantially canceled and is likely to be difficult to hear independently of the tweeter, it is possible to apply a larger voltage than that of the tweeter, and it is possible to increase the output of the woofer. In addition, it is possible to suppress sound leakage by narrowing the corresponding band to a high frequency range with the tweeter and reducing the size of the tweeter, and reproducing a high-frequency sound for which it is difficult to suppress sound leakage only near the user's ear.

### Sixth Embodiment

In a case where the acoustic signal output device 100 is installed in a bedroom, which is a space where silence is demanded, it is convenient to easily change an area where a sound can be heard in order to prevent the sound from being heard by a family member sleeping next. Therefore, in the present embodiment, a mode in which a member enabling an easy change in the front surface direction of the acoustic signal output device 100 is attached will be described.

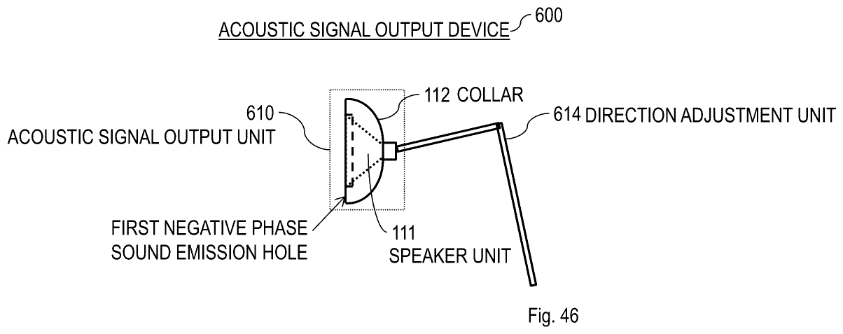

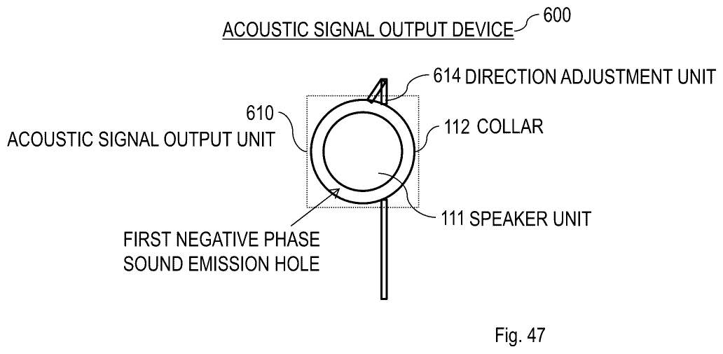

Hereinafter, the acoustic signal output device 600 will be described with reference to FIGS. 46 to 48. FIGS. 46 and 47 are diagrams illustrating a configuration of the acoustic signal output device 600, FIG. 46 is a diagram illustrating a state in which the acoustic signal output device 600 is viewed from the side surface direction, and FIG. 47 is a diagram illustrating a state in which the acoustic signal output device 600 is viewed from the front surface direction. As illustrated in FIG. 46, the acoustic signal output device 600 includes an acoustic signal output unit 610 and a direction adjustment unit 614. The acoustic signal output unit 610 includes a speaker unit 111 and a collar 112. The collar 112 is a housing that accommodates a part of the speaker unit 111.

The collar 112 is a housing for causing the negative phase sound, which is a sound emitted from the speaker unit 111 in the back surface direction of the speaker unit 111, to travel around in the front surface direction of the speaker unit 111, and the collar 112 is provided with a hole (hereinafter, referred to as a first negative phase sound emission hole) for emitting the negative phase sound that has traveled around in the front surface direction of the speaker unit 111.

The collar 112 accommodates a part of the speaker unit 111 in such a manner that a path from a hole of the speaker unit 111 for emitting the negative phase sound to the first negative phase sound emission hole is short so that the negative phase sound emitted from the first negative phase sound emission hole in the front surface direction of the speaker unit 111 and the positive phase sound emitted from the speaker unit 111 in the front surface direction of the speaker unit 111 have a substantially anti-phase relationship in the predetermined frequency band in the front surface direction of the speaker unit 111, and the frequency at which resonance of the internal space of the collar 112 formed with respect to the speaker unit 111 occurs (hereinafter, resonance frequency) is high. Note that the predetermined frequency band is desirably a band lower than or equal to the resonance frequency of the internal space of the collar 112 formed with respect to the speaker unit 111. In order to shorten the path from the hole of the speaker unit 111 for emitting the negative phase sound to the first negative phase sound emission hole, when the speaker unit 111 is a speaker unit used for a dynamic speaker, it is sufficient if a magnet portion constituting the speaker unit 111 is not accommodated in the collar 112. In addition, in order to increase the resonance frequency of the internal space of the collar 112 formed with respect to the speaker unit 111, it is sufficient if the resonance frequency is adjusted using one or more methods of three methods: increasing an area S of the first negative phase sound emission hole, decreasing a volume V of the internal space, and shortening a length L of the first negative phase sound emission hole, in consideration of Formula (1) regarding resonant frequency f_{H} of Helmholtz resonance, and the collar 112 accommodates a part of the speaker unit 111.

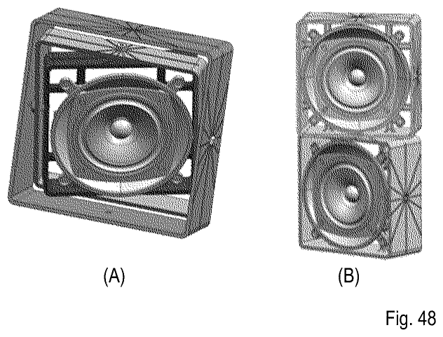

The direction adjustment unit 614 is a member attached to the acoustic signal output unit 610 in order to change the front surface direction of the acoustic signal output unit 610. The user can change the area in which sound leakage is desired to be suppressed by adjusting the direction adjustment unit 614. The direction adjustment unit 614 may be, for example, a member such as an arm of a desk light (see FIG. 46). In addition, the direction adjustment unit 614 may be a member such as a frame attached to enclose the periphery of the acoustic signal output unit 610 as illustrated in FIG. 48(A). Note that the acoustic signal output device 600 may include two or more acoustic signal output units 610, and in this case, the direction adjustment unit 614 may be attached to each acoustic signal output unit 610 so that the front surface direction of the acoustic signal output unit 610 can be changed (see FIG. 48(B)).

The area where a sound is not heard is formed in the side surface direction of the acoustic signal output unit 610. Therefore, when the front surface direction of the acoustic signal output unit 610 is changed using the direction adjustment unit 614 so that the user whom a sound is not desired to be heard is positioned in the side surface direction of the acoustic signal output unit 610, it is possible to prevent the user from hearing the sound.

As in the first embodiment, a member (hereinafter, referred to as a baffle) for adjusting such that the position where the negative phase sound and the positive phase sound cancel each other in a low frequency range becomes a position far from the speaker unit may be attached to the speaker unit, thereby adjusting the position desired to be the sweet spot in the front surface direction of the speaker unit. That is, a baffle 113, which is a member for preventing the negative phase sound emitted from the first negative phase sound emission hole and the positive phase sound emitted from the speaker unit 111 from canceling each other at the position desired to be the sweet spot in the front surface direction of the speaker unit 111, may be attached to the speaker unit 111.

According to an embodiment of the present invention, it is possible to enlarge the sweet spot in a limited area such as the vicinity of the speaker unit. The user can change the area in which sound leakage is desired to be suppressed by adjusting the front surface direction of the acoustic signal output unit 610.

### Seventh Embodiment

In the first embodiment, sound leakage in the back surface direction, particularly sound leakage in a high frequency range may be a concern. Therefore, in the present embodiment, a mode for suppressing sound leakage in the back surface direction will be described.

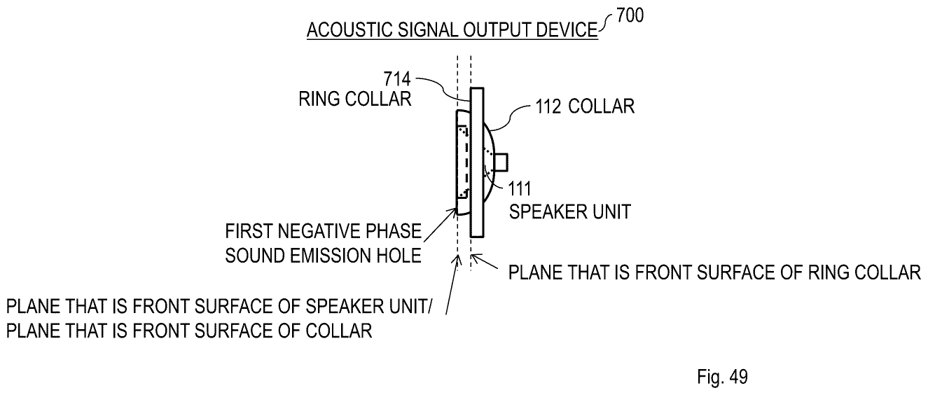

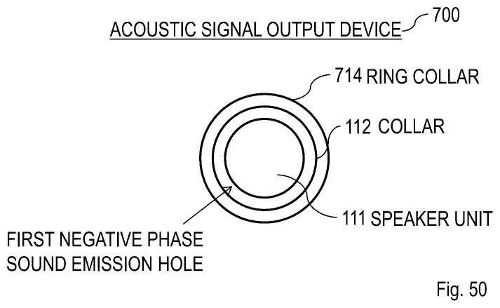

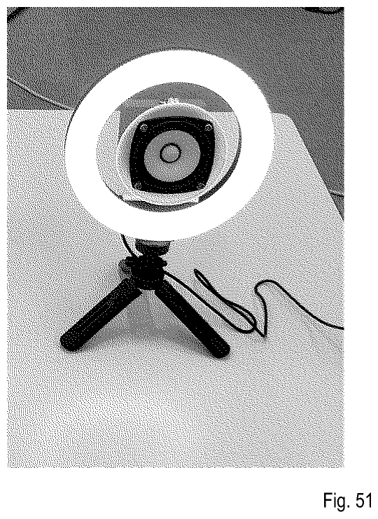

Hereinafter, the acoustic signal output device 700 will be described with reference to FIGS. 49 to 52. FIGS. 49 and 50 are diagrams illustrating a configuration of the acoustic signal output device 700, FIG. 49 is a diagram illustrating a state in which the acoustic signal output device 700 is viewed from the side surface direction, and FIG. 50 is a diagram illustrating a state in which the acoustic signal output device 700 is viewed from the front surface direction. As illustrated in FIG. 49, the acoustic signal output device 700 includes a speaker unit 111, a collar 112, and a ring collar 714. The collar 112 is a housing that accommodates a part of the speaker unit 111. The ring collar 714 is a ring-shaped member having a size capable of covering the periphery of the collar 112 in the side surface direction. The ring collar 714 may have any shape as long as it has a size capable of covering the periphery of the collar 112 in the side surface direction. The shape of the ring collar 714 when viewed from the front surface of the speaker unit 111 may be, for example, substantially circular or substantially elliptical. Note that a baffle (not illustrated), which is a member for filling a gap, may be attached between the collar 112 and the ring collar 714. In this case, sound leakage in the back surface direction of the speaker unit 111 can be suppressed. On the other hand, a gap may be provided between the collar 112 and the ring collar 714. In this case, a sound can travel from between the collar 112 and the ring collar 714 in the back surface direction of the speaker unit 111, and as a result, sound leakage can be suppressed. In addition, as illustrated in FIG. 51, the ring collar 714 may have an illumination function.

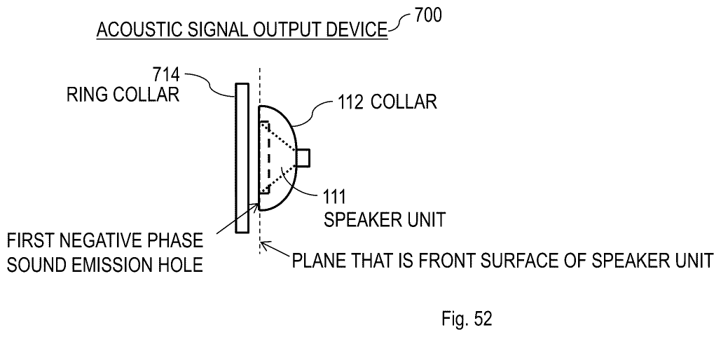

In addition, for example, the shapes of the diaphragm of the speaker unit 111 and the ring collar 714 when viewed from the front surface of the speaker unit 111 may be substantially circular, the centers thereof may be substantially the same, and the ring collar 714 may be disposed so as to be positioned in the side surface direction of the speaker unit 111 (see FIG. 49) and may be disposed so as to be positioned in the front surface direction of the speaker unit 111 when viewed from the plane that is the front surface of the speaker unit 111 (see FIG. 52).

Note that, as illustrated in FIG. 49, a plane that is the front surface of the speaker unit 111, a plane that is the front surface of the collar 112, and a plane that is the front surface of the ring collar 714 are preferably substantially parallel. In FIG. 49, the plane that is the front surface of the speaker unit 111 and the plane that is the front surface of the collar 112 are substantially the same.

The collar 112 is a housing for causing the negative phase sound, which is a sound emitted from the speaker unit 111 in the back surface direction of the speaker unit 111, to travel around in the front surface direction of the speaker unit 111, and the collar 112 is provided with a hole (hereinafter, referred to as a first negative phase sound emission hole) for emitting the negative phase sound that has traveled around in the front surface direction of the speaker unit 111.

The collar 112 accommodates a part of the speaker unit 111 in such a manner that a path from a hole of the speaker unit 111 for emitting the negative phase sound to the first negative phase sound emission hole is short so that the negative phase sound emitted from the first negative phase sound emission hole in the front surface direction of the speaker unit 111 and the positive phase sound emitted from the speaker unit 111 in the front surface direction of the speaker unit 111 have a substantially anti-phase relationship in the predetermined frequency band in the front surface direction of the speaker unit 111, and the frequency at which resonance of the internal space of the collar 112 formed with respect to the speaker unit 111 occurs (hereinafter, resonance frequency) is high. Note that the predetermined frequency band is desirably a band lower than or equal to the resonance frequency of the internal space of the collar 112 formed with respect to the speaker unit 111. In order to shorten the path from the hole of the speaker unit 111 for emitting the negative phase sound to the first negative phase sound emission hole, when the speaker unit 111 is a speaker unit used for a dynamic speaker, it is sufficient if a magnet portion constituting the speaker unit 111 is not accommodated in the collar 112. In addition, in order to increase the resonance frequency of the internal space of the collar 112 formed with respect to the speaker unit 111, it is sufficient if the resonance frequency is adjusted using one or more methods of three methods: increasing an area S of the first negative phase sound emission hole, decreasing a volume V of the internal space, and shortening a length L of the first negative phase sound emission hole, in consideration of Formula (1) regarding resonant frequency f_{H} of Helmholtz resonance, and the collar 112 accommodates a part of the speaker unit 111.

As in the first embodiment, a member (hereinafter, referred to as a baffle) for adjusting such that the position where the negative phase sound and the positive phase sound cancel each other in a low frequency range becomes a position far from the speaker unit may be attached to the speaker unit, thereby adjusting the position desired to be the sweet spot in the front surface direction of the speaker unit. That is, a baffle 113, which is a member for preventing the negative phase sound emitted from the first negative phase sound emission hole and the positive phase sound emitted from the speaker unit 111 from canceling each other at the position desired to be the sweet spot in the front surface direction of the speaker unit 111, may be attached to the speaker unit 111.

According to an embodiment of the present invention, it is possible to enlarge the sweet spot in a limited area such as the vicinity of the speaker unit. By using the ring collar, sound leakage in a high frequency range can be suppressed. In addition, sound leakage in the back surface direction can be suppressed.

### <Supplementary Notes>

The descriptions of the embodiments of the present invention described above have been presented for purposes of illustration and description. There is no intention to be comprehensive or to limit the invention to the disclosed precise form. Modifications and variations can be made according to the foregoing teaching. The embodiments have been selected and represented in order to provide the best illustration of the principles of the present invention and to enable those skilled in the art to utilize the present invention in various embodiments with various modifications added such that the present invention is appropriate for considered practical use. All such modifications and variations are within the scope of the present invention as defined by the appended claims interpreted in accordance with a fairly and legally equitable breadth.

1. An acoustic signal output device comprising:
a speaker unit;
a collar that is a housing accommodating a part of the speaker unit to cause a sound (hereinafter, referred to as a negative phase sound) emitted from the speaker unit in a back surface direction of the speaker unit to travel around in a front surface direction of the speaker unit; and
a ring collar that is a ring-shaped member having a size capable of covering a periphery of the collar in a side surface direction,
wherein
the collar is provided with a hole (hereinafter, referred to as a first negative phase sound emission hole) for emitting the negative phase sound in the front surface direction of the speaker unit, and
the collar accommodates a part of the speaker unit in such a manner that a path from a hole of the speaker unit for emitting the negative phase sound to the first negative phase sound emission hole is short so that the negative phase sound emitted from the first negative phase sound emission hole and a sound (hereinafter, referred to as a positive phase sound) emitted from the speaker unit in the front surface direction of the speaker unit have a substantially anti-phase relationship in a predetermined frequency band in the front surface direction of the speaker unit, and a resonance frequency of an internal space of the collar formed with respect to the speaker unit is high.

2. The acoustic signal output device according to claim 1, wherein
a baffle that is a member for suppressing sound leakage in the back surface direction of the speaker unit is attached between the collar and the ring collar.

3. The acoustic signal output device according to claim 1, wherein
the ring collar has an illumination function.

4. The acoustic signal output device according to claim 1, wherein
one or more methods of three methods: increasing an area of the first negative phase sound emission hole, decreasing a volume of the internal space, and shortening a length of the first negative phase sound emission hole are used to increase the resonance frequency of the internal space.

5. The acoustic signal output device according to claim 1, wherein
a baffle that is a member for preventing the negative phase sound emitted from the first negative phase sound emission hole and the positive phase sound from canceling each other at a position desired to be a sweet spot in the front surface direction of the speaker unit is attached to the speaker unit.
